(19) United States
(12) Patent Application Publication
(10) Pub. No.: US 2026/0245081 A1
(43) Pub. Date: Aug. 20, 2026

(54) METHOD AND SYSTEM FOR AN IN-NETWORK DIGITAL USER TO ACT ON BEHALF OF USER PRESERVING USER PRIVACY

(71) Applicant: Huawei Technologies Co., Ltd., Shenzhen (CN)

(72) Inventors: Nimal Gamini Senarath, Ottawa (CA); Remziye Irem Bor Yaliniz, Ottawa (CA)

(21) Appl. No.: 19/649,965

(22) Filed: Apr. 16, 2026

Related U.S. Application Data
(63) Continuation of application No. PCT/CN2024/100745, filed on Jun. 21, 2024.
(60) Provisional application No. 63/591,267, filed on Oct. 18, 2023.

(51) Int. Cl. G06Q 20/38; G06Q 20/02

(52) U.S. Cl. CPC G06Q 20/383; G06Q 20/02; G06Q 20/38215; G06Q 20/3829

(57) ABSTRACT

Embodiments of the present application relate to a method and apparatus for a digital user to receive payment and send payment anonymously. In an example method, a digital user (D-User) resides in a network element and performs functionality on behalf of a physical user, such as a wireless communication device. The D-User may receive a request from a third party to identify a process to authorize an agreement with the third party. The method further includes obtaining a temporary credential from a certification authority (CA) to authorize the agreement with the third party; sending a message to the third party, where the message contains the temporary credential that allows the third party to verify an authorization with the CA; and exchanging confirmation information with the third party regarding authorization of the agreement.

### CROSS-REFERENCE TO RELATED APPLICATIONS

This application is a continuation of International Patent Application No. PCT/CN2024/100745, filed on Jun. 21, 2024, which claims the benefits of U.S. Provisional Application No. 63/591,267, filed on Oct. 18, 2023, the disclosures of which are hereby incorporated by reference in their entireties.

### TECHNICAL FIELD

The present disclosure relates to wireless communications, and in particular, the present disclosure relates to privacy in wireless communications.

### BACKGROUND

Many new trends may trigger the consideration and design of future wireless networks. These may include a new network infrastructure capability, such as cloud natured/friendly infrastructures that are broadly deployed. These may further include new (relatively) matured techniques, such as Artificial Intelligence (AI) large scale models, Data de-privacy, Block chain, among other options, that have made significant progress and significantly impact on the and human life and society as a whole.

Trends for next generation wireless networks may further include new applications and services. These may for example include AI services, Data (sensing) services, Digital world services, among other options. that are broadly applied in industry/business and used by individual customers. Trends may further include a more global/open/collaborative operation trend. Specifically, a more open and more collaborative operation mode is becoming common practice in many fields.

New expectations and stricter requirements on future networks may also drive rethinking and development of a new generation of wireless networks. These requirements may include privacy and trustworthiness; simplified standardization; rapid deployment, among other requirements.

All of the above, drives future network architecture research work.

### SUMMARY

It is an object of the present disclosure to provide a digital user architecture for an in-network digital user to act on behalf of a user to preserve the user's privacy.

In a first aspect, a method at a network element may be provided. The method may include receiving a request to identify a process to authorize an agreement with a third party at a digital user (D-User) within the network element, the D-User representing a user and having a temporary identifier and the request from the third party relating to a previous negotiation the D-User had with the third party using the temporary identifier while the D-User was acting on behalf of the user, and obtaining a temporary credential from a certification authority (CA) to authorize the agreement with the third party. The method may further include sending a message to the third party containing the temporary credential, thereby allowing the third party to verify an authorization with the CA and exchanging confirmation information with the third party regarding authorization of the agreement.

In some embodiments, the sending the message may include sending the message to the third party through a privacy preserving portal (PPP), wherein the PPP changes a source identifier or source address of the message to the temporary identifier.

In some embodiments, the temporary credential may be valid only for a single transaction or request.

In some embodiments, the receiving the request, the providing the temporary credential, and the exchanging confirmation information may all use the temporary identifier to ensure anonymity between the D-User and the third party.

In some embodiments, the obtaining the temporary credential may include sending a message through a privacy preserving portal (PPP), wherein the PPP changes a source identifier in the message to the PPP ID or address to ensure that the CA is unaware of who is using services of the CA.

In some embodiments, prior to obtaining the temporary credential from the CA, the method may further comprise obtaining an authentic representation certificate from the user, wherein the authentic representation certificate is obtained by the user from the CA, and providing the authentic representation certificate to the CA when obtaining the temporary credential.

In some embodiments, the authentic representation certificate may be used to transfer authority to the D-User to act on behalf of the user for a specified set of transaction types.

In some embodiments, the set of transaction types includes making a payment to the third party; receiving a payment from the third party; negotiating with the third party on behalf of the user for transactions; agreeing to a negotiated settlement; and authorizing a transaction on behalf of the user.

In some embodiments, the temporary identifier is one or more of a temporary user identifier, temporary user address, temporary D-User address, and a negotiation event identifier.

In some embodiments, the previous negotiation was for a service obtained by the user from the third party, and wherein the process to authorize the request may be to make payment from the user to the third party.

In some embodiments, the CA is a financial organization, and the temporary credential includes an identifier for the financial organization to provide a payment to the third party.

In some embodiments, the exchanging confirmation information may include one or more of: receiving confirmation at the D-User that the payment was received by the third party; sending confirmation from the D-User to the third party that the payment was received; and receiving an acknowledgement from the third party that the third party received the signed agreement.

In some embodiments, the previous negotiation was for a service provided by the user to the third party, wherein the CA is a financial organization, and wherein obtaining the temporary credential may comprise obtaining account details of a temporary account owned by the user.

In some embodiments, the third party may make a payment to the temporary account according to the previous negotiation and before the exchanging the confirmation information.

In some embodiments, the previous negotiation was for an agreement between the user and the third party for an activity.

In a further aspect, a network element comprising a processor and a communications subsystem may be provided. The network element may be configured to receive a request to identify a process to authorize an agreement with a third party at a digital user (D-User) within the network element, the D-User representing a user and having a temporary identifier and the request from the third party relating to a previous negotiation the D-User had with the third party using the temporary identifier while the D-User was acting on behalf of the user, and obtain a temporary credential from a certification authority (CA) to authorize the agreement with the third party. The network element may further be configured to send a message to the third party containing the temporary credential, thereby allowing the third party to verify an authorization with the CA and exchange confirmation information with the third party regarding authorization of the agreement.

In a further aspect, a method for a user using an electronic device to have anonymous communication with a third party may be provided. The establishment of the anonymous communication at the electronic device may comprise providing an anonymous communication identification tag (ACID) to the electronic device to identify user messages as belonging to the anonymous communication. The method may further comprise receiving a first message with the ACID in the service identification field and a user address in the source address field and sending a second message to the third party after replacing the user address of the first message with a temporary identifier and changing a destination address to an address for the third party. The method may further comprise receiving a response from the third party at the temporary address using the temporary identifier, changing the header of the response from the temporary identifier to the user identifier to create a modified response, and forwarding the modified response back to the user.

In some embodiments, the first message may be a modified version of an original message sent by a user application, the original message consisting of a third party address as the destination address in a header and an original payload encrypted with a third party public key, wherein modification of the first message may be done by an Internal User Application function (IUF) by changing the header to include a network element address as the destination address and by preparing a new payload encrypted by the encryption keys used for communication between the user and the D-User (DUKey) in the electronic device.

In some embodiments, the new payload may be prepared by adding the third party address and the ACID to the original payload.

In some embodiments, the method may further comprise receiving a data packet by the D-User within the electronic device, decrypting the message using DUKey, and removing the ACID and the 3d party address from the modified payload. The method may further comprise adding a third party address as the destination address; and forwarding the message to a PPP function inside the electronic device.

In some embodiments, the PPP function inside the electronic device may replace the source address of the received message by the temporary identifier and may forward the message to the third party.

In a further aspect, an electronic device having a processor and communications subsystem may be provided. The electronic device may be configured to provide an anonymous communication identification tag (ACID) to the electronic device to identify user messages as belonging to the anonymous communication. The electronic device may be further configured to receive a first message with the ACID in the service identification field and a user address in the source address field and sending a second message to the third party after replacing the user address of the first message with a temporary identifier and change a destination address to an address for the third party. The electronic device may further be configured to receive a response from the third party at the temporary address using the temporary identifier, change the header of the response from the temporary identifier to the user identifier to create a modified response, and forward the modified response back to the user.

In a further aspect a method at a network element may be provided. The method may include receiving, at a digital user (D-User) entity a representative of a physical user from a User Centric and Managed (UCM) service, a request to identify a method to receive a payment, and obtaining a temporary account identifier from a financial organization that is to receive the payment. The method may further include providing the temporary account identifier to the UCM service and receiving confirmation of the payment from the UCM service.

In some embodiments, the receiving the request may proceed through a Privacy Preserving Portal which changes a temporary user identifier in the request to an identifier for the D-User.

In some embodiments, the D-User may provide a service or data through the UCM to a service consumer, and wherein payment is brokered by the UCM from the service consumer.

In some embodiments, the temporary account identifier may keep an account holder anonymous to the UCM.

In some embodiments, the D-User may be part of a D-User platform, and wherein the D-User platform may have a minimum threshold number of D-Users.

In some embodiments, the method may further include providing information to a physical user associated with the D-User regarding the payment.

In some embodiments, the temporary account identifier may be associated with an account of the physical user at the financial organization.

In some embodiments, the providing the temporary account identifier may flow through a Privacy Preserving Portal which changes an identifier for the D-User to a temporary user identifier prior to forwarding the temporary account identifier to the UCM service.

In some embodiments, the payment may flow through the UCM service and the D-User may be unaware of an identity of the payor.

In some embodiments, the D-User may include a secure signing code certified by a certificate authority.

In a further aspect, a network element having a processor and a communications subsystem may be provided. The network element may be configured to receive, at a digital user service (D-User) at the network element, from a User Centric and Managed (UCM) service, a request to identify a method to receive a payment, and obtain a temporary account identifier from a financial organization that is to receive the payment. The network element may further be configured to provide the temporary account identifier to the UCM service, and receive confirmation of the payment from the UCM service.

In some embodiments, the network element may be configured to receive the request through a Privacy Preserving Portal which changes a temporary user identifier in the request to an identifier for the D-User.

In some embodiments, the D-User may provide a service or data through the UCM to a service consumer, and wherein payment is brokered by the UCM from the service consumer.

In some embodiments, the temporary account identifier may keep an account holder anonymous to the UCM.

In some embodiments, the D-User may be part of a D-User platform, and wherein the D-User platform may have a minimum threshold number of D-Users.

In some embodiments, the network element may further be configured to provide information to a physical user associated with the D-User regarding the payment.

In some embodiments, the temporary account identifier may be associated with an account of the physical user at the financial organization.

In some embodiments, the network element may be configured to provide the temporary account identifier through a Privacy Preserving Portal which changes an identifier for the D-User to a temporary user identifier prior to forwarding the temporary account identifier to the UCM service.

In some embodiments, the payment may flow through the UCM service, and the D-User may be unaware of an identity of the payor.

In a further aspect, a computer readable medium having stored thereon executable code for execution by a processor of a network element may be provided. The instruction code, when executed by the processor, may cause the network element to receive, at a digital user service (D-User) at the network element, from a User Centric and Managed (UCM) service, a request to identify a method to receive a payment and obtain a temporary account identifier from a financial organization that is to receive the payment. The instruction code, when executed by the processor, may further cause the network element to provide the temporary account identifier to the UCM service, and receive confirmation of the payment from the UCM service.

### BRIEF DESCRIPTION OF THE DRAWINGS

The present disclosure will be better understood with reference to the drawings in which:

FIG. 1 is a graphical representation of a Virtual User Equipment in a 3GPP network according to at least one embodiment of the present disclosure.

FIG. 2 is a graphical representation of an architecture for a NET4DW according to at least one embodiment of the present disclosure.

FIG. 3 is a graphical representation of a networking environment according to at least one embodiment of the present disclosure.

FIG. 4 is a graphical representation of a communications system according to at least one embodiment of the present disclosure.

FIG. 5 is a graphical representation of an electronic device communicating with a base station according to at least one embodiment of the present disclosure.

FIG. 6 is a block diagram of a device according to at least one embodiment of the present disclosure.

FIG. 7 is a block diagram of a structure for a 6G system according to at least one embodiment of the present disclosure.

FIG. 8 is a dataflow diagram showing a user paying for a service anonymously using a D-User platform.

FIG. 9 is a dataflow diagram showing a user accepting payment anonymously using a D-User platform.

FIG. 10 is a block diagram showing functionality with a D-User platform.

FIG. 11 is a dataflow diagram showing a user anonymously obtaining query results from a queried server using a D-User platform.

FIG. 12 is a dataflow diagram showing a network aware creation of a UCM service for a P-User.

FIG. 13 is a dataflow diagram showing a network agnostic creation of a UCM service for a P-User.

FIG. 14 is a dataflow diagram showing the obtaining of payments for data sharing anonymously.

FIG. 15 is a block diagram of an exemplary device for implementing embodiments of the present disclosure.

### DETAILED DESCRIPTION OF ILLUSTRATIVE EMBODIMENTS

The present disclosure is directed to a method and system for an in-network digital user to act on behalf of a user to preserve the user's privacy.

In the embodiments below, the proposed network architecture is anything centric (X-centric) Service Based Architecture (SBA) (Anything as a Service (XaaS)) based and Cloud-native.

Further, in some embodiments, the System network architecture design may support new services which could be developed/deployed by third parties; and may embrace a more open ecosystem to open a door to technically capable third parties; and may enable better trustworthiness management, among other features. Therefore, the embodiments described below may use such design.

When interacting with third parties, user privacy may be exposed in several ways. A Virtual User Equipment (VUE) is a digital representation of a user (D-User) installed inside the network. Since the VUE is inside the network, it can closely interact with the network in order to provide user with more control over the services the user obtains from the network, creating user empowerment.

Such services may be provided as an added service, and may be referred to as User Centric and Managed (UCM) Services. There can be different levels of control and management that can be given to a user, referred to herein as empowerment levels.

Some UCM services that may be provided include but are not limited to:
A user may define a service capability, i.e., a user may define what services the user needs rather than only selecting services provided by a network;
A user may manage and control behaviors and features of the services provided by the network. Currently a user may select a service from the standard set of services provided by the network. However, a user cannot control or manage the network behaviors;
A network may be designed such that each user is served with a specific part of the network (e.g. exclusive logical slice) and have a certain control on that part of the network. This is currently possible in 5G systems by obtaining a complete network slice acting like a vertical for its own use, although there may be a heavy cost and large resource wastage. What is expected is user can obtain parts of the network or network elements for its exclusive use dynamically, which cannot be done using current technologies.

Services may be provided considering user's context (e.g., user in the loop, user context is used for dynamic network functionality/operation modifications). Currently such technologies are not available.

User device(s)/networks may become part of the network. For example, a User Equipment (UE) may become a Base Station (BS) or relay, a drone BS or relay, an application server, among other options. While there are current proposals for physical layer improvements such as ad hoc networks and drone relays, this may be further improved.

A user may become a producer or provider of services to the network, such as an AI service, neighbor information, video services, BS service provided by a user device or drone BS, among other options.

While the above are available as concepts, tighter interaction may be useful.

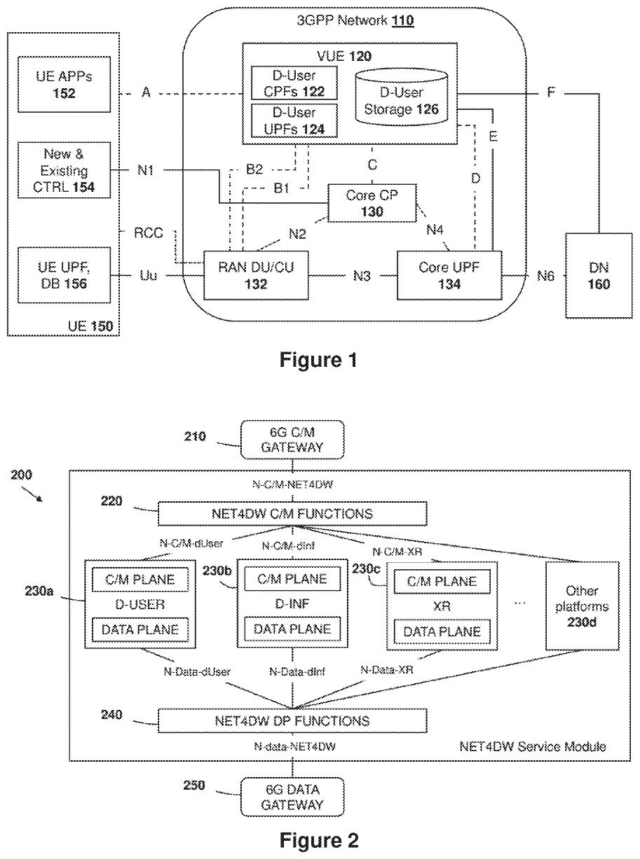

A VUE inside the network can interact with the network to facilitate these services. For this purpose, the VUE may include control plane functions, user plane functions, data storage, and required internal and external interfaces. Reference is now made to FIG. 1, which illustrates an example of interfaces of a VUE.

In the embodiment of FIG. 1, a Third Generation Partnership Project (3GPP) network 110 may include one or more virtual user equipments (VUEs) 120. VUE 120 may include the D-user Control Plane Functions (CPFs) 122, the D-user User Plane Functions (UPFs) 124 as well as D-user storage 126.

3GPP network 110 may further include a Core control plane (CP) 130, a Radio Access Network (RAN) Distributed Unit (DU)/Centralized Unit (CU) 132, and a Core UPF 134.

A UE 150 may include UE Applications (APPs) 152, new and existing control functionality 154, as well as the UE UPF and database (DB) 156.

A Data Network (DN) 160 may further form part of the system.

Within the 3GPP network 110, the VUE 120 may communicate with the Core CP 130 through a C interface. The VUE 120 may communicate with the RAN DU/CU 132 through a B1 and B2 interface. The VUE 120 may communicate with the Core UPF 134 through a D and E interface. The VUE 120 may communicate with UE 150 through an A interface. The VUE 120 may communicate with the DN 160 through an F interface.

The Core CP 130 may communicate with the RAN DU/CU 132 through an N2 interface. The Core CP 130 may communicate with the Core UPF 134 through an N4 interface. The Core CP 130 may communicate with the New and Existing CTRL 154 through an N1 interface.

The RAN DU/CU 132 may communicate with the Core UPF 134 through an N3 interface. The RAN DU/CU 132 may communicate with UE 150 through an RCC interface and with the UE UPF, DB 156 through a Uu interface.

The Core UPF 134 may communicate with the DN 160 through an N6 interface.

Detailed methods and systems on how a network could host a VUE (i.e. D-User) inside the network with all the facilities are provided below.

A Trusted Execution Environment (TEE) is a secure area of a main processor which provides code and data integrity for the applications running inside the TEE (e.g. Intel SGX or AMD SEV, among other options). Therefore, applications can securely store and process data which cannot even be detected by the operating system. For example, some systems, such as Intel SGX, work by creating a secure area of memory, called an enclave, where an application can run. This enclave is protected by a set of cryptographic keys that are unique to the application and the system it is running on. This can also be considered as a virtual machine (VM) as it is operated on a separate Central Processing Unit (CPU). When an application is executed, it is sealed inside the enclave, where it can run securely without fear of interference from other processes or the operating system.

Additionally, TEEs include a feature called remote attestation, which allows a remote party to verify the integrity and security of an enclave, thus providing a way to trust the enclave. Remote attestation works by allowing the remote party to send a request to the enclave, asking it to provide proof of its identity and integrity. The enclave then responds by providing a cryptographic signature that is based on the enclave's unique identity and a set of measurements of the enclave's code and data. The remote party can then verify the signature using a public key provided by the enclave. If the signature is valid, this indicates that the enclave is authentic and has not been tampered with, allowing the remote party to trust the enclave and its data.

Thus, by creating a VUE inside a TEE, even the hosting network may not be able to access user data or the codes used by the VUE.

Network for Digital World (NET4DW) is a service module which can provide Digital World (DW) services which includes a capability to construct, control and manage digital world. Digital world can be defined as digital realization of a physical world including people, animals, and infrastructure. The NET4DW service facilitates DW applications running in the DW. In particular, a NET4DW module may include a D-User digital representation of a physical user (P-User). Currently some form of digital representation of a user is available in certain metaverses or servers such as Facebook™, Amazon™, Google™, among other options. The representation can vary from application to application and can vary from using user data to controlling personal items and actions on behalf of the user.

An X-centric based 6G architecture may provide Digital World (DW) services through a Network for Digital World (NET4DW). A NET4DW may provide DW services such as a D-User service, digital twin services, and extended Reality (X-R) services, amongst others.

As shown in FIG. 2, NET4DW may include D-User platforms, D-Inf platforms, and any other DW platforms such as X-R platforms. These are commonly termed D-XX modules in the present disclosure. The D-Inf platform may contain digital representatives (D-Reps) of different physical objects such a buildings, roads or organizations.

In FIG. 2, C/M refers to control and management plane and DP refers to data plane. Net4DW C/M functions are the control and management functions of the NET4DW to manage and coordinate the platform interactions required for different DW applications. It may also include the C/M Gateway (G/W) function though which the NET4DW C/M functions interact with the external C/M functions. Similarly, DP functions are the data plane functions such as routing and data processing functions. Each platform has its own C/M and DP functions and they may connect to Net4DW functions through G/W functions.

Thus, referring to FIG. 2, an architecture of an NET4DW service module according to at least one embodiment of the present disclosure is illustrated. Specifically, as seen in FIG. 2, a network may comprise a service module 200. Service module 200 comprises D-User platform 230a, D-Inf platform 230b, an X-R service platform 230c and other platforms 230d. More generally, service module 200 may comprise any number of services platforms and the platforms 230a, 230b, and 230c are provided for illustrative purposes only.

D-User platform 230a may manage D-Users. For example, D-User platform 230a may create, delete, and update D-Users. Similarly, D-Inf platform 230b may manage digital twin services, and X-R service platform 230c may manage X-R services. Digital twin services provide digital representations of physical entities.

Each of platforms 230a, 230b, 230c and 230d may communicate with Control and Management (C/M) functions 220 through a C/M plane, as well as with Data Processing (DP) functions 240 through a data plane. C/M functions 220 manage and coordinate platform interactions, and DP functions 240 perform specific processing and operations such as routing.

C/M functions 220 are connected to the NET4DW trough C/M gateway 210, and DP functions 240 are connected to the NET4DW through Data gateway 250.

Embodiments of the present disclosure provide for a digital user inside a network to act on behalf of the user, thereby preserving privacy. For example, a user can make a payment anonymously to a service provider when the service is also consumed anonymously. Anonymity means that even the service provider does not know who the end user was, who obtained the service, and who made the payment on behalf of the user. Further, a financial institution may also not know for which purpose the payment was made.

Some embodiments of the present disclosure provide a method to obtain content from the content providers while preserving privacy, and then arranging payment for the content while also preserving privacy. None of the network, financial organization or the content provider are aware of the user who downloaded content and who made the payment.

According to some embodiments, a service consumer may be required to pay to a user when the user provided the service to the service consumer anonymously. For example, a data consumer, who obtained data from a user anonymously using a D-User, may want to make the payment using the data consumer's financial organization. This transaction is done such that the consumer's financial organization is not aware of the user or the user's financial institution.

In some embodiments a method to share data to the third party data consumers while preserving privacy and then arranging to provide the payment to the user while also preserving privacy is provided. In this case, none of the network, financial organization or the data consumer is aware of the user who shared data and who received the payment.

In some embodiments, the D-User may agree to an external contract on behalf of the user. This may be needed when a user provides a service to a third party or obtains a service from a third party.

In some embodiments, a method to obtain user data while preserving privacy and a payment system to pay for the data and/or a negotiation method for creating an agreement may be provided. This may include a method to find the needs of the user and serve the user without knowing the user's identity. In some cases, user AI engines may be used to coordinate with third party AI engines sharing user analytical and raw data for this purpose.

In some embodiments, a system to share user data with a data consumer while preserving privacy may be provided. This may be done using a user controlled function (UCF) instantiated in the network, a privacy preserving portal (PPP) and a shared data portal (SDP) inside the network to obtain a payment from the data consumer while preserving privacy.

This may be done by receiving sharable data that can be shared with external entities with a privacy preserving level (PPL) indication. Further, data may be categorized according to privacy preserving levels with its historical information. PPP information may be obtained to assess the different privacy preserving techniques needed for different types of data.

Further, data may be sent to the PPP to be derivatized and forwarded to a network controlled multi-user data portal to be shared with external data consumers. Shared data may be comprised of one or more of:
User personal information/interests (habits, needs, locations, communication groups, etc.);
User's content interests (user interests to obtain content from content providers, prefetching, communication needs);
User data that a user may need to be analyzed by a third party AI machine (e.g., AI4Net);
User data (may include raw data) or data models that may need to be exchanged for joint AI analysis with a third party.

A further description of a set of UCM services and functions that may be used in conjunction with the present application is further described in commonly owned patent application PCT/CN2023/106032 entitled “METHOD, APPARATUS AND SYSTEM FOR A USER TO CONTROL NETWORK SERVICES BY A VIRTUAL USER EQUIPMENT,” which is incorporated by reference in its entirety herein.

Embodiments described in the present disclosure may be used in conjunction with, or part of, an operating environment, which is now described.

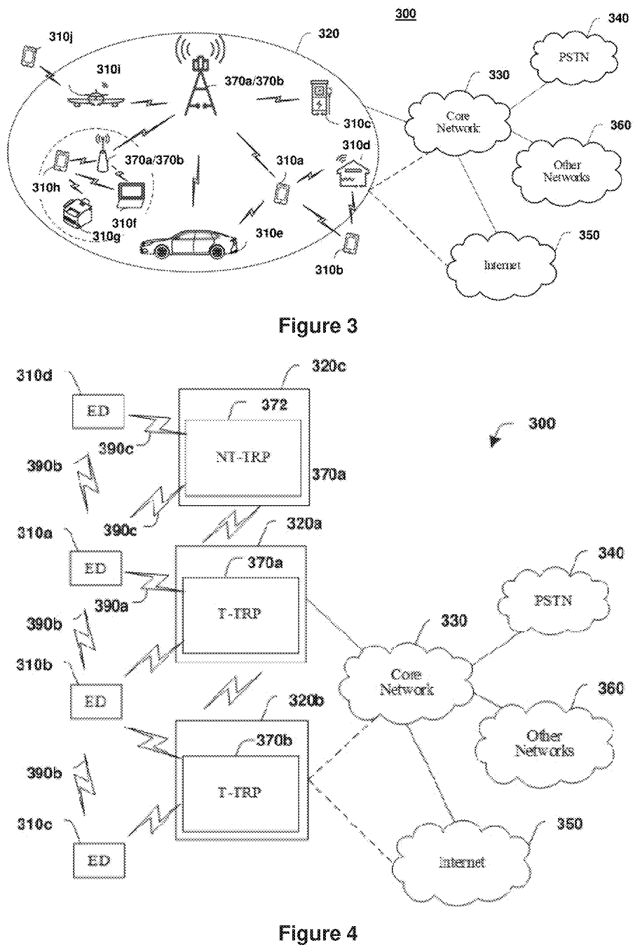

Referring to FIG. 3, as an illustrative and non-limiting example, a simplified schematic illustration of a communication system is provided. The communication system 300 comprises a radio access network 320. The radio access network 320 may be a next generation (e.g. sixth generation (6G) or later) radio access network, or a legacy (e.g. 5G, 4G,) radio access network. One or more communication electronic devices (ED) 310a, 310b, 310c, 310d, 310e, 310f, 310g, 310h, 310i, 310j (generically referred to as 310) may be interconnected to one another or connected to one or more network nodes (370a, 370b, generically referred to as 370) in the radio access network 320. A core network 330 may be a part of the communication system and may be dependent or independent of the radio access technology used in the communication system 300. Also, the communication system 300 comprises a public switched telephone network (PSTN) 340, the internet 350, and other networks 360.

Reference is now made to FIG. 4, which illustrates an example communication system 300. In general, the communication system 300 enables multiple wireless or wired elements to communicate data and other content. The purpose of the communication system 300 may be to provide content, such as voice, data, video, and/or text, via broadcast, multicast, groupcast, unicast, and the like. The communication system 300 may operate by sharing resources, such as carrier spectrum bandwidth, between its constituent elements. The communication system 300 may include a terrestrial communication system and/or a non-terrestrial communication system. The communication system 300 may provide a wide range of communication services and applications (such as earth monitoring, remote sensing, passive sensing and positioning, navigation and tracking, autonomous delivery and mobility, and the like). The communication system 300 may provide a high degree of availability and robustness through a joint operation of a terrestrial communication system and a non-terrestrial communication system. For example, integrating a non-terrestrial communication system (or components thereof) into a terrestrial communication system can result in what may be considered a heterogeneous network comprising multiple layers. Compared to conventional communication networks, the heterogeneous network may achieve better overall performance through efficient multi-link joint operation, more flexible functionality sharing, and faster physical layer link switching between terrestrial networks and non-terrestrial networks.

The terrestrial communication system and the non-terrestrial communication system could be considered sub-systems of the communication system. In the example shown in FIG. 4, the communication system 300 includes electronic devices (ED) 310a, 310b, 310c, 310d (generically referred to as ED 310), radio access networks (RANs) 320a, 320b, a non-terrestrial communication network 320c, a core network 330, a public switched telephone network (PSTN) 340, the Internet 350, and other networks 360. The RANs 320a, 320b include respective base stations (BSs) 370a, 370b, which may be generically referred to as terrestrial transmit and receive points (T-TRPs) 370a, 370b. The non-terrestrial communication network 320c includes an access node 372, which may be generically referred to as a non-terrestrial transmit and receive point (NT-TRP) 372.

Any ED 310 may be alternatively or additionally configured to interface, access, or communicate with any T-TRP 370a,370b and NT-TRP 372, the Internet 350, the core network 330, the PSTN 340, the other networks 360, or any combination of the preceding. In some examples, ED 310a may communicate an uplink and/or downlink transmission over a terrestrial air interface 390a with T-TRP 370a. In some examples, the EDs 310a, 310b, 310c, and 310d may also communicate directly with one another via one or more sidelink air interfaces 390b. In some examples, ED 310d may communicate an uplink and/or downlink transmission over a non-terrestrial air interface 390c with NT-TRP 372.

The air interfaces 390a and 390b may use similar communication technology, such as any suitable radio access technology. For example, the communication system 300 may implement one or more channel access methods, such as code division multiple access (CDMA), space division multiple access (SDMA), time division multiple access (TDMA), frequency division multiple access (FDMA), orthogonal FDMA (OFDMA), or single-carrier FDMA (SC-FDMA, also known as discrete Fourier transform spread OFDMA, DFT-s-OFDMA) in the air interfaces 390a and 390b. The air interfaces 390a and 390b may utilize other higher dimension signal spaces, which may involve a combination of orthogonal and/or non-orthogonal dimension.

The non-terrestrial air interface 390c can enable communication between the ED 310d and one or multiple NT-TRPs 372 via a wireless link or simply a link. For some examples, the link is a dedicated connection for unicast transmission, a connection for broadcast transmission, or a connection between a group of EDs 310 and one or multiple NT-TRPs 372 for multicast transmission.

The RANs 320a and 320b are in communication with the core network 330 to provide the EDs 310a, 310b, and 310c with various services such as voice, data, and other services. The RANs 320a and 320b and/or the core network 330 may be in direct or indirect communication with one or more other RANs (not shown), which may or may not be directly served by core network 330, and may or may not employ the same radio access technology as RAN 320a, RAN 320b or both. The core network 330 may also serve as a gateway access between (i) the RANs 320a and 320b or EDs 310a, 310b, and 310c or both, and (ii) other networks (such as the PSTN 340, the Internet 350, and the other networks 360). In addition, some or all of the EDs 310a, 310b, and 310c may include functionality for communicating with different wireless networks over different wireless links using different wireless technologies and/or protocols. Instead of wireless communication (or in addition thereto), the EDs 310a, 310b, and 310c may communicate via wired communication channels to a service provider or switch (not shown), and to the Internet 350. PSTN 340 may include circuit switched telephone networks for providing plain old telephone service (POTS). Internet 350 may include a network of computers and subnets (intranets) or both, and incorporate protocols, such as Internet Protocol (IP), Transmission Control Protocol (TCP), User Datagram Protocol (UDP). EDs 310a, 310b, and 310c may be multimode devices capable of operation according to multiple radio access technologies, and incorporate multiple transceivers necessary to support such.

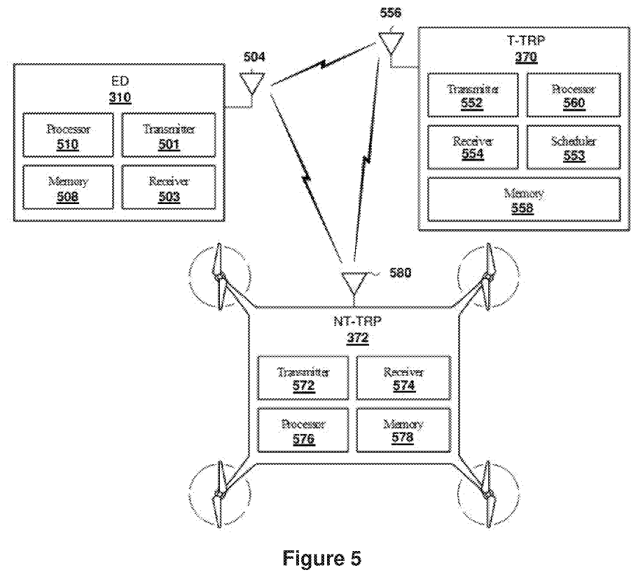

FIG. 5 illustrates another example of an ED 310 and a base station 370a, 370b and/or 370c. The ED 310 is used to connect persons, objects, and machines, amongst others. The ED 310 may be widely used in various scenarios including, for example, cellular communications, device-to-device (D2D), vehicle to everything (V2X), peer-to-peer (P2P), machine-to-machine (M2M), machine-type communications (MTC), internet of things (IoT), virtual reality (VR), augmented reality (AR), mixed reality (MR), metaverse, digital twin, industrial control, self-driving, remote medical, smart grid, smart furniture, smart office, smart wearable, smart transportation, smart city, drones, robots, remote sensing, passive sensing, positioning, navigation and tracking, autonomous delivery and mobility, amongst others.

Each ED 310 represents any suitable end user device for wireless operation and may include such devices (or may be referred to) as a user equipment/device (UE), a wireless transmit/receive unit (WTRU), a mobile station, a fixed or mobile subscriber unit, a cellular telephone, a station (STA), a machine type communication (MTC) device, a personal digital assistant (PDA), a smartphone, a laptop, a computer, a tablet, a wireless sensor, a consumer electronics device, a smart book, a vehicle, a car, a truck, a bus, a train, or an IoT device, wearable devices (such as a watch, a pair of glasses, head mounted equipment, and the like), an industrial device, or an apparatus in (e.g. communication module, modem, or chip) or comprising the forgoing devices, among other possibilities. Future generation EDs 310 may be referred to using other terms. The base station 370a and 370b is a T-TRP and will hereafter be referred to as T-TRP 370. Also shown in FIG. 5, a NT-TRP will hereafter be referred to as NT-TRP 372. Each ED 310 connected to T-TRP 370 and/or NT-TRP 372 can be dynamically or semi-statically turned-on (i.e., established, activated, or enabled), turned-off (i.e., released, deactivated, or disabled) and/or configured in response to one of more of: connection availability and connection necessity.

The ED 310 includes a transmitter 501 and a receiver 503 coupled to one or more antennas 504. Only one antenna 504 is illustrated to avoid congestion in the drawing. One, some, or all of the antennas 504 may alternatively be panels. The transmitter 501 and the receiver 503 may be integrated, e.g. as a transceiver. The transceiver is configured to modulate data or other content for transmission by at least one antenna 504 or Network Interface Controller (NIC). The transceiver is also configured to demodulate data or other content received by the at least one antenna 504. Each transceiver includes any suitable structure for generating signals for wireless or wired transmission and/or processing signals received wirelessly or by wire. Each antenna 504 includes any suitable structure for transmitting and/or receiving wireless or wired signals.

The ED 310 includes at least one memory 508. The memory 508 stores instructions and data used, generated, or collected by the ED 310. For example, the memory 508 could store software instructions or modules configured to implement some or all of the functionality and/or embodiments described herein and that are executed by one or more processing unit(s) (e.g., a processor 510). Each memory 508 includes any suitable volatile and/or non-volatile storage and retrieval device(s). Any suitable type of memory may be used, such as random access memory (RAM), read only memory (ROM), hard disk, optical disc, subscriber identity module (SIM) card, memory stick, secure digital (SD) memory card, on-processor cache, and the like.

The ED 310 may further include one or more input/output devices (not shown) or interfaces (such as a wired interface to the Internet 350 in FIG. 4). The input/output devices or interfaces permit interaction with a user or other devices in the network. Each input/output device or interface includes any suitable structure for providing information to or receiving information from a user, and/or for network interface communications. Suitable structures include, for example, a speaker, microphone, keypad, keyboard, display, touch screen, and the like.

The ED 310 includes the processor 510 for performing operations including those operations related to preparing a transmission for uplink transmission to the NT-TRP 372 and/or the T-TRP 370; those operations related to processing downlink transmissions received from the NT-TRP 372 and/or the T-TRP 370; and those operations related to processing sidelink transmission to and from another ED 310. Processing operations related to preparing a transmission for uplink transmission may include operations such as encoding, modulating, transmit beamforming, and generating symbols for transmission. Processing operations related to processing downlink transmissions may include operations such as receive beamforming, demodulating and decoding received symbols. Depending upon the embodiment, a downlink transmission may be received by the receiver 503, possibly using receive beamforming, and the processor 510 may extract signaling from the downlink transmission (e.g. by detecting and/or decoding the signaling). An example of signaling may be a reference signal transmitted by the NT-TRP 372 and/or by the T-TRP 370. In some embodiments, the processor 510 implements the transmit beamforming and/or the receive beamforming based on the indication of beam direction, e.g. beam angle information (BAI), received from the T-TRP 370. In some embodiments, the processor 510 may perform operations relating to network access (e.g. initial access) and/or downlink synchronization, such as operations relating to detecting a synchronization sequence, decoding and obtaining the system information, and the like. In some embodiments, the processor 510 may perform channel estimation, e.g. using a reference signal received from the NT-TRP 372 and/or from the T-TRP 370.

Although not illustrated, the processor 510 may form part of the transmitter 501 and/or part of the receiver 503. Although not illustrated, the memory 508 may form part of the processor 510.

The processor 510, the processing components of the transmitter 501, and the processing components of the receiver 503 may each be implemented by the same or different one or more processors that are configured to execute instructions stored in a memory (e.g. in the memory 508). Alternatively, some or all of the processor 510, the processing components of the transmitter 501, and the processing components of the receiver 503 may each be implemented using dedicated circuitry, such as a programmed field-programmable gate array (FPGA), an application-specific integrated circuit (ASIC), or a hardware accelerator such as a graphics processing unit (GPU) or an artificial intelligence (AI) accelerator.

The T-TRP 370 may be known by other names in some implementations, such as a base station, a base transceiver station (BTS), a radio base station, a network node, a network device, a device on the network side, a transmit/receive node, a Node B, an evolved NodeB (eNodeB or eNB), a Home eNodeB, a next Generation NodeB (gNB), a transmission point (TP), a site controller, an access point (AP), a wireless router, a relay station, a terrestrial node, a terrestrial network device, a terrestrial base station, a base band unit (BBU), a remote radio unit (RRU), an active antenna unit (AAU), a remote radio head (RRH), a central unit (CU), a distributed unit (DU), a positioning node, among other possibilities. The T-TRP 370 may be a macro BS, a pico BS, a relay node, a donor node, or the like, or combinations thereof. The T-TRP 370 may refer to the forgoing devices or refer to apparatus (e.g. a communication module, a modem, or a chip) in the forgoing devices.

In some embodiments, the parts of the T-TRP 370 may be distributed. For example, some of the modules of the T-TRP 370 may be located remote from the equipment that houses the antennas 556 for the T-TRP 370, and may be coupled to the equipment that houses the antennas 556 over a communication link (not shown) sometimes known as front haul, such as common public radio interface (CPRI). Therefore, in some embodiments, the term T-TRP 370 may also refer to modules on the network side that perform processing operations, such as determining the location of the ED 310, resource allocation (scheduling), message generation, and encoding/decoding, and that are not necessarily part of the equipment that houses the antennas 556 of the T-TRP 370. The modules may also be coupled to other T-TRPs. In some embodiments, the T-TRP 370 may actually be a plurality of T-TRPs that are operating together to serve the ED 310, e.g. through the use of coordinated multipoint transmissions.

The T-TRP 370 includes at least one transmitter 552 and at least one receiver 554 coupled to one or more antennas 556. Only one antenna 556 is illustrated to avoid congestion in the drawing. One, some, or all of the antennas 556 may alternatively be panels. The transmitter 552 and the receiver 554 may be integrated as a transceiver. The T-TRP 370 further includes a processor 560 for performing operations including those related to: preparing a transmission for downlink transmission to the ED 310, processing an uplink transmission received from the ED 310, preparing a transmission for backhaul transmission to the NT-TRP 372, and processing a transmission received over backhaul from the NT-TRP 372. Processing operations related to preparing a transmission for downlink or backhaul transmission may include operations such as encoding, modulating, precoding (e.g. multiple input multiple output (MIMO) precoding), transmit beamforming, and generating symbols for transmission. Processing operations related to processing received transmissions in the uplink or over backhaul may include operations such as receive beamforming, demodulating received symbols, and decoding received symbols. The processor 560 may also perform operations relating to network access (e.g. initial access) and/or downlink synchronization, such as generating the content of synchronization signal blocks (SSBs), generating the system information, and the like. In some embodiments, the processor 560 also generates an indication of beam direction, e.g. BAI, which may be scheduled for transmission by a scheduler 553. The processor 560 performs other network-side processing operations described herein, such as determining the location of the ED 310, determining where to deploy the NT-TRP 372, and the like. In some embodiments, the processor 560 may generate signaling, e.g. to configure one or more parameters of the ED 310 and/or one or more parameters of the NT-TRP 372. Any signaling generated by the processor 560 is sent by the transmitter 552. Note that “signaling”, as used herein, may alternatively be called control signaling. Signaling may be transmitted in a physical layer control channel, e.g. a physical downlink control channel (PDCCH), in which case the signaling may be known as dynamic signaling. Signaling transmitted in a downlink physical layer control channel may be known as Downlink Control Information (DCI). Signaling transmitted in an uplink physical layer control channel may be known as Uplink Control Information (UCI). Signaling transmitted in a sidelink physical layer control channel may be known as Sidelink Control Information (SCI). Signaling may be included in a higher-layer (e.g., higher than physical layer) packet transmitted in a physical layer data channel, e.g. in a physical downlink shared channel (PDSCH), in which case the signaling may be known as higher-layer signaling, static signaling, or semi-static signaling. Higher-layer signaling may also refer to Radio Resource Control (RRC) protocol signaling or Media Access Control-Control Element (MAC-CE) signaling.

The scheduler 553 may be coupled to the processor 560. The scheduler 553 may be included within or operated separately from the T-TRP 370. The scheduler 553 may schedule uplink, downlink, sidelink, and/or backhaul transmissions, including issuing scheduling grants and/or configuring scheduling-free (e.g., “configured grant”) resources. The T-TRP 370 further includes a memory 558 for storing information and data. The memory 558 stores instructions and data used, generated, or collected by the T-TRP 370. For example, the memory 558 could store software instructions or modules configured to implement some or all of the functionality and/or embodiments described herein and that are executed by the processor 560.

Although not illustrated, the processor 560 may form part of the transmitter 552 and/or part of the receiver 554. Also, although not illustrated, the processor 560 may implement the scheduler 553. Although not illustrated, the memory 558 may form part of the processor 560.

The processor 560, the scheduler 553, the processing components of the transmitter 552, and the processing components of the receiver 554 may each be implemented by the same or different one or more processors that are configured to execute instructions stored in a memory, e.g. in the memory 558. Alternatively, some or all of the processor 560, the scheduler 553, the processing components of the transmitter 552, and the processing components of the receiver 554 may be implemented using dedicated circuitry, such as a programmed FPGA, a hardware accelerator (e.g., a GPU or AI accelerator), or an ASIC.

Although the NT-TRP 372 is illustrated as a drone only as an example, the NT-TRP 372 may be implemented in any suitable non-terrestrial form, such as satellites and high altitude platforms, including international mobile telecommunication base stations and unmanned aerial vehicles, for example. Also, the NT-TRP 372 may be known by other names in some implementations, such as a non-terrestrial node, a non-terrestrial network device, or a non-terrestrial base station. The NT-TRP 372 includes a transmitter 572 and a receiver 574 coupled to one or more antennas 580. Only one antenna 580 is illustrated to avoid congestion in the drawing. One, some, or all of the antennas may alternatively be panels. The transmitter 572 and the receiver 574 may be integrated as a transceiver. The NT-TRP 372 further includes a processor 576 for performing operations including those related to: preparing a transmission for downlink transmission to the ED 310, processing an uplink transmission received from the ED 310, preparing a transmission for backhaul transmission to T-TRP 370, and processing a transmission received over backhaul from the T-TRP 370. Processing operations related to preparing a transmission for downlink or backhaul transmission may include operations such as encoding, modulating, precoding (e.g. MIMO precoding), transmit beamforming, and generating symbols for transmission. Processing operations related to processing received transmissions in the uplink or over backhaul may include operations such as receive beamforming, demodulating received symbols, and decoding received symbols. In some embodiments, the processor 576 implements the transmit beamforming and/or receive beamforming based on beam direction information (e.g. BAI) received from the T-TRP 370. In some embodiments, the processor 576 may generate signaling, e.g. to configure one or more parameters of the ED 310. In some embodiments, the NT-TRP 372 implements physical layer processing, but does not implement higher layer functions such as functions at the medium access control (MAC) or radio link control (RLC) layer. As this is only an example, more generally, the NT-TRP 372 may implement higher layer functions in addition to physical layer processing.

The NT-TRP 372 further includes a memory 578 for storing information and data. Although not illustrated, the processor 576 may form part of the transmitter 572 and/or part of the receiver 574. Although not illustrated, the memory 578 may form part of the processor 576.

The processor 576, the processing components of the transmitter 572, and the processing components of the receiver 574 may each be implemented by the same or different one or more processors that are configured to execute instructions stored in a memory, e.g. in the memory 578. Alternatively, some or all of the processor 576, the processing components of the transmitter 572, and the processing components of the receiver 574 may be implemented using dedicated circuitry, such as a programmed FPGA, a hardware accelerator (e.g., a GPU or AI accelerator), or an ASIC. In some embodiments, the NT-TRP 372 may actually be a plurality of NT-TRPs that are operating together to serve the ED 310, e.g. through coordinated multipoint transmissions.

The T-TRP 370, the NT-TRP 372, and/or the ED 310 may include other components, but these have been omitted for the sake of clarity.

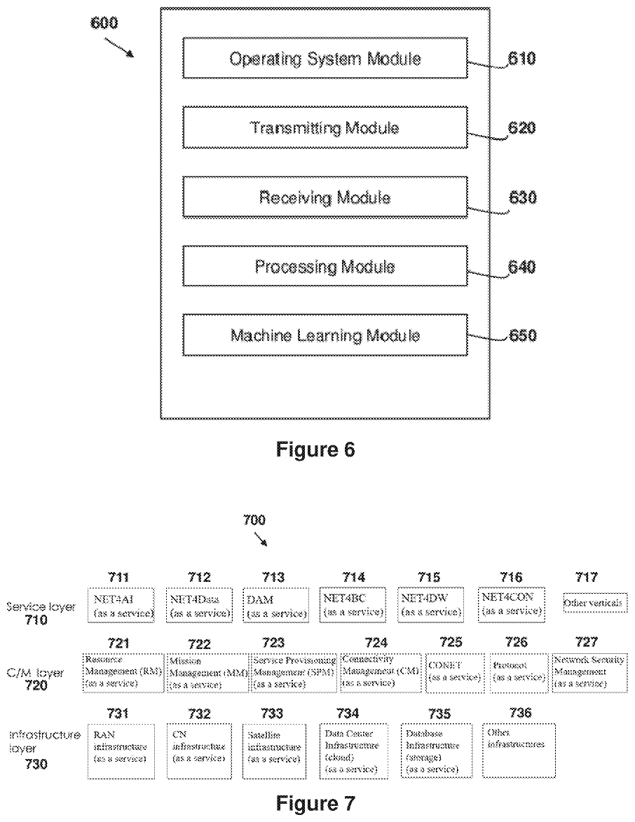

One or more steps of the embodiment methods provided herein may be performed by corresponding units or modules, according to FIG. 6. FIG. 6 illustrates units or modules in a device 600, such as in the ED 310, in the T-TRP 370, or in the NT-TRP 372. For example, the device may comprise an Operating System module 610. A signal may be transmitted by a transmitting unit or by a transmitting module 620. A signal may be received by a receiving unit or by a receiving module 630. A signal may be processed by a processing unit or a processing module 640. Other steps may be performed by an artificial intelligence (AI) or machine learning (ML) module 650. The respective units or modules may be implemented using hardware, one or more components or devices that execute software, or a combination thereof. For instance, one or more of the units or modules may be a circuit such as an integrated circuit. Examples of an integrated circuit includes a programmed FPGA, a GPU, or an ASIC. For instance, one or more of the units or modules may be logical such as a logical function performed by a circuit, by a portion of an integrated circuit, or by software instructions executed by a processor. It will be appreciated that where the modules are implemented using software for execution by a processor for example, the modules may be retrieved by a processor, in whole or part as needed, individually or together for processing, in single or multiple instances, and that the modules themselves may include instructions for further deployment and instantiation.

Additional details regarding the EDs 310, the T-TRP 370, and the NT-TRP 372 are known to those of skill in the art. As such, these details are omitted here.

The solution described in the application is applicable to a next generation (e.g. sixth generation (6G) or later) network, or a legacy (e.g. 5G, 4G,) network.

The proposed System architecture is defined to support XaaS services by using techniques such as Network Function Virtualization and Network Slicing. The System architecture utilizes service-based interactions between services.

The System leverages service-based architecture and XaaS concept. XaaS services in the System are categorized into three layers. A System conceptual structure 700 is shown in FIG. 7.

Infrastructure Layer 730 includes infrastructures supporting new services. Among them are wireless networks (RAN, CN) infrastructures 731 and 732, Cloud/data center infrastructures 734, satellite infrastructure 733, and storage/database infrastructures 735. Infrastructure Layer 730 may further include other infrastructures 736 including for example, sensing networks, and the like. These infrastructures can be provided by a single provider or by multiple providers.

Each of the infrastructures could have its control and management functions, denoted as C/M functions, for infrastructure management. Each of these infrastructures is one type of Infrastructure as a Service.

Control and Management (C/M) layer 720 includes control and management services of the System. They are developed and deployed by using slicing techniques and utilizing resource provided by infrastructure layer. 6G services in Control and Management (C/M) layer are:

Resource Management (RM) as a Service 721 provides a capability of life-cycle management of a variety of slices and over-the-air resource assignment to wireless devices.

Mission Management (MM) as a Service 722 provides a capability to program provisioning of XaaS services at a Service Layer to provide mission services. A mission is defined as a service provided to customers by the System. A mission can be a type of services which is provided by a single XaaS service or a type of services that needs contributions from multiple XaaS services.

Confederation Network (CONET) as a Service 725 provides a capability to enable multiple partners to jointly provide services. This capability is provided by confederation formation, mutual authentication, mutual authorization among partners and negotiation of an agreement on recording and retracing selected actions performed by partners, in order to assure a trustworthy environment within System operations.

Service Provisioning Management (SPM) 723 as a Service provides a capability of control and management of service access by customers and provisioning of requested services. The capability is provided by unified mutual authentication, authorization and policy, key management, QoS assurance and charging between any pair of XaaS service provider and customer. The customers include end-customers not only in physical world, but also digital representatives in digital world.

Connectivity Management (CM) as a Service 724 leverages 5G connectivity management functions, but with an extension to include digital world.

Protocol as a Service 726 provides a capability to design service customized protocol stacks for identified interfaces. The protocol stacks could be pre-defined for on-demand selection, or could be designed on-demand.

Network Security as a Service 727 provides a capability for owners of infrastructures to detect potential security risks of their infrastructures.

XaaS services in C/M Layer 720 support control and management of the System itself and also provide support to verticals if requested. For example, the RM service 721 may serve a RAN for over-the-air resource management and may also provide service to a vertical for the vertical's over-the-air resource allocation to its end-customers. The XaaS in C/M layer may be deployed by using slicing techniques.

Service Layer 710 includes services which provide services to customers. Service Layer 710 may include:

An Artificial Intelligence (AI) as a service 711 denoted as NET4AI as a Service (NET4AI for short). Artificial Intelligence as a service 711 provides AI capability to support a variety of AI applications.

A service of data collection, data sanitization, data analysis and data delivery is denoted as DAM as a Service 713 (DAM for short). This service provides lifecycle management of statistic data, including acquisition, de-privatization, analysis and delivery of data which from any type of sensor, device, network function, and the like.

A service of data storage and data sharing is denoted as NET4Data as a Service 712 (NET4Data for short). This service provides trustworthy storage and sharing of data for data owners, while following recognized authorities' regulations on control of identified data.

A Digital World service, denoted as NET4DW as a Service 715 (NET4DW for short), provides a capability to construct, control and manage a digital realization of the physical world.

A block chain service is denoted as NET4BC as a Service 714 (NET4BC for short). NET4Con as a Service 716 (NET4CON for short) provides support to block chain services.

Enhanced connectivity service, e.g., network for connectivity (NET4CON) as a Service 716 supports the exchange of messages and data among new services.

XaaS services of the Service Layer 710 are developed and deployed by using resources provided by Infrastructure Layer 730 and by utilizing Network Function Virtualization and Slicing techniques. The capability of each service is provided by its control and management functions and service specific data process functions.

In addition to supporting XaaS services from Service Layer 710, the System leverages the 5G System for provisioning of vertical services. The difference between XaaS services and other verticals is that a vertical is a pure customer which needs other XaaS services to enable its operation, while each XaaS service provides its capabilities to customers.

Any pair of XaaS services of the System could also be mutual customers and providers of each other. For example, an infrastructure owner may provide its resource to Xaas services in Service Layer 710 and C/M Layer 720, and RM service 721 may need the capabilities provided by NET4AI 711, DAM 713, and NET4DW 715 in order to utilize vertical slicing in the provision of resource management services. Similarly, CONET service 725 and NET4Data service 712 may need the capability provided by NET4BC for their operation.

Example key concepts of a System include:

Defining basic XaaS Services by decoupling comprehensive types of services into basic XaaS services. A basic XaaS service provides a unique capability to enable a specific type of service, such as a NET4AI service, a NET4DW service, a DAM service, a NET4Data service, a Block chain service, a mission management service, amongst others.

Allowing the joint operation of the System by multiple partners.

Defining a Data Plane of the System including processing functions of data planes for XaaS services. Programing the interconnection of these functions, by the mission management service, enables a variety of customized customer services.

Simplifying the System architecture by categorizing basic control services and management services and combining them as basic XaaS services in the Control and Management (C/M) Layer.

Defining the C/M Layer of the System including C/M functions as XaaS services and optionally including 5G Control Plane (CP), such as Access and Mobility Functions (AMF).

Defining a Basic Architecture Structure (BAS) which is a unified basic structure with minimized number of interfaces and is independent from types of infrastructures.

Simplifying standardization, development and deployment of the System using the BAS concept, while supporting a variety of infrastructure deployment scenarios.

Adapting to a variety of deployment scenarios by applying the BAS or a subset of it to infrastructures based on capability, capacity and requirement of the infrastructure networks.

Leveraging the Service Based Interface (SBI) interface concept and applying SBI interaction in both C/M plane and data plane.

Simplifying the SBI interfaces by introducing trustworthy gateways in both the C/M plane and the data plane.

Improving trustworthiness from the perspective of operators of the System by introducing CONET capability, NET4BC capability and anonymous service provisioning provided by trustworthy gateways in the C/M plane and data plane of the System.

Improving trustworthiness for end customer privacy protection by unified mutual authentication, Identity Management (IDM), data sanitization and the like, as provided by the SPM service, the DAM service and the Block Chain service.

Simplifying roaming management for wireless devices, in the physical world and the digital world, by unifying authentication across all participating partners and customers.

Supporting multiple development paths from the 5G System to the System by defining multiple architecture options without incurring much efforts due to the introduction of the BAS concept.

Supporting backward compatibility by utilizing the benefits of a Service Based Architecture (SBA) and its add-on features, allowing 5G users to use the System to access 5G services.

Supporting future extensions by adding new XaaS services with minimal impact on standardization and deployment, due to the anonymous service provisioning concept implemented by trustworthy gateways in the C/M plane and in the data plane.

### Digital User Anonymous Payments

The embodiments of the present disclosure provide for a digital user inside a network to act on behalf of the user, thereby preserving privacy. For example, a user may have to make a payment anonymously to a service provider for a service the user obtains from the service provider anonymously. Anonymity means that even the service provider does not know who the end user was, who obtained the service, and who made the payment on behalf of the user. Further, the financial institution does not know the purpose for which the payment is made.

User privacy may be important for a user, as currently users share their personal data to many organizations, including Over-the-Top (OTT) media service providers such as Google™, Amazon™, YouTube™, among others, and other service providers such as shops, equipment providers, among others. Therefore, a unified data protection scheme that allows for the preserving of privacy while still allowing a user to interact with the third party web sites is provided. Data that can be exposed during these interactions includes, but is not limited to, a user obtaining a payment for a service that the user provided online while preserving privacy (e.g. shared user data using a D-User). In this case, the user cannot obtain payment from the data consumer's financial institute (CFI) because the data consumer is not aware of the user or user's financial institution and/or the CFI may know the type of service obtained by the data consumer if the data consumer's privacy is leaked, which would affect user privacy.

Data that can be exposed during these interactions further includes data related to a service obtained online while preserving privacy (e.g. anonymously) from a service provider that a user must pay for. The payment cannot be paid directly to the service provider because the service provider does not know the actual user and/or the service provider financial institute may find out that the user obtained that type of service.

Some aspects of the present disclosure further provide a method to make an agreement with an institution on behalf of the user while preserving privacy.

Reference is now made to FIG. 8, which provides a dataflow diagram showing a method to make a payment anonymously from a service provider for a service obtained online anonymously using an in-network D-User. Please note that the payment anonymously scenario is just an example for the present application, which does not limit the scenario applied to the application.

In the embodiment of FIG. 8, a physical user (P-User) 810 may communicate using a D-User Platform 812. The network can be a trusted network or untrusted network. If the network should not be aware of the entities or their addresses the D-User is communicating with the D-User Platform 812 may include a plurality of D-Users 814, along with PPP 816 and the D-User platform should be created in an isolated enclave such as a TEE.

Both the P-User 810 and D-User 814 may communicate with the user's financial or certification authority (CA) 820.

Further, in some embodiments, a Shared Content Interest Portal (SCIP) 822 may act as an intermediary between a user and a content provider. SCIP 822 may also be referred to as a shared content interest database to pre-fetch content.

A content or work request provider, referred to herein as service provider 824 may provide content and expect to be paid for such content.

As seen by reference line 830, the P-User may come to an agreement with the financial organization (FO) or a certification authority (CA) 820 to give the authority to the D-User 814 to authorize on behalf of the P-User (e.g. obtain payment from the financial organization). For this, the P-User receives a certificate of authority (COA), also referred to as an authentic representation certificate, e.g., an authorization code and a Transaction identifier (TID) or a list of transaction types, which can be used by another entity (e.g. D-User) to act on behalf of the P-User for specified types of transactions listed in COA. These transaction types may include, but are not limited to:
Signing a document;
Making a payment to a third party;
Receiving a payment from a third party;
Negotiate with a third party on behalf of user for certain transactions;
Agreeing to a negotiated settlement;
Or authorize on behalf of the user for a transaction.

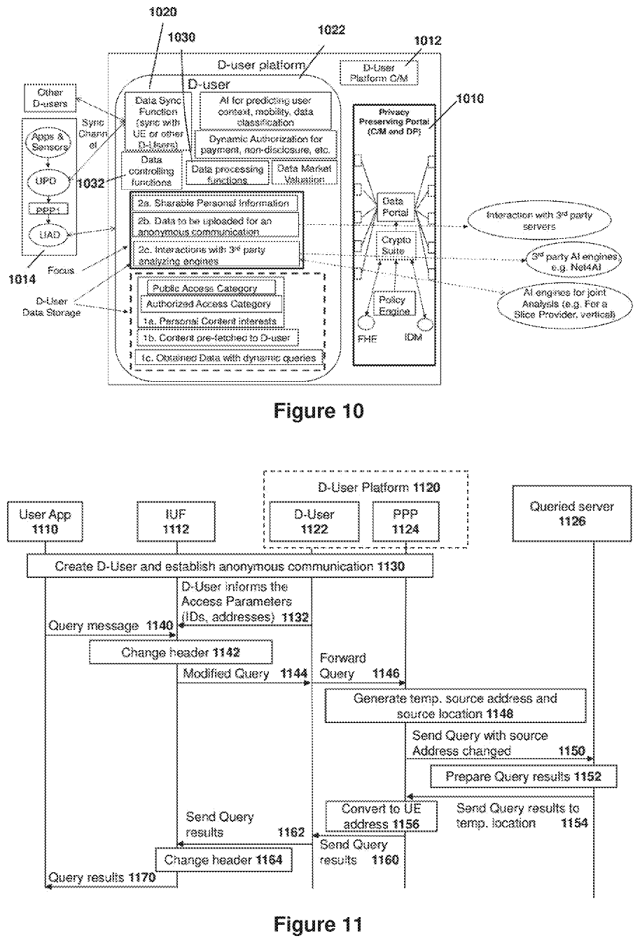

These transaction types are specified in the agreement with the CA. In this case, the P-User may communicate with the CA and PPP anonymously, as indicated later in this document (related to FIG. 10).

After receiving the authentic representation certificate, it may be passed to the D-User 814, by the P-User as shown with message 832. The P-User sends this authentic representation certificate to the D-User so that the D-User can present this to the CA and act on behalf of the user for the specified types of transactions.

D-User may register with the CA/FO as an authorized entity of the P-User using the COA with a specific customer identification and obtain an identification as a legal entity who can act on behalf of the user for the transaction types listed in the COA. The CA may not be aware of actual D-User location, address or identity (e.g. D-User sends only the COA) as the communication with CA happens via PPP which anonymize the identity. However, CA may contact the user to verify the D-User claim. After obtaining the representation with identification tag the D-User can use this to obtain individual credentials to act on behalf of user for different types of transactions with the external entities.

The set of transaction types include one or more of (but are not limited to):
Making a payment to a third party
Receiving a payment from a third party;
Negotiate with a third party on behalf of user for certain transactions;
Agreeing to a negotiated settlement;
Or authorize on behalf of the user for a transaction.

The service provider 824 (e.g. a content provider) has already negotiated and have come to an agreement (previous negotiation). The user needs to authorize/approve the agreement when the service provider request it and D-User can do it on behalf of the user. For example, authorizing the agreement may include signing a document, agreeing to a deal, authorizing a payment, obtaining a temporary financial account to obtain a payment, among other options including a D-User acting on behalf of the user. This happens when the service provider informs the D-User (using messages 836 or 838) to authorize the agreement according to the previous negotiation using the same temporary identifier used for the previous negotiation. This may be sent through a function controlled by the hosting network such as SCIP/SDP or directly to the PPP. Therefore, the third party is not aware of the identity or the address of the D-User even during authorization process. D-User verify the request and send an authorization message with COA to the CA via PPP anonymously to authorize the agreement. IT may use a specific agreement identifier so that the CA can certify that the user had agreed to the particular agreement.

For example, a previous negotiation may be to obtain a particular service (e.g. an interested content) by the user or the D-User from a service provider for an agreed amount of payment.

The service provider may provide the agreed amount of payment using the SCIP or/and PPP as the intermediary and is not aware of the real identity of the D-User or the user (e.g., content that a user may be interested in was provided to the D-User 814 along with an agreement with the D-User 814 for payment).

In one embodiment, the SCIP is also not aware of the real identify or address of the D-User, since all messages goes though the PPP, wherein the PPP changes the D-User identifier (D-User ID or the address) to a temporary identifier for the communications to the SCIP and temporary identifier to the D-User identifier for the communications from the SCIP to the D-User. The temporary identifier for the D-User is generated by the PPP. In one embodiment, the SCIP is a part of the hosting network of the D-User platform and since the SCIP is not aware of the D-User communications, the hosting network is also not aware of the D-User communications. In this case (in order for the hosting network to not be aware of the communications of the D-User), the D-User platform is fully isolated from the hosting network, e.g. using a TEE and D-User platform should have a sufficient number of D-Users to keep the anonymity.

In one embodiment of the present disclosure, if the SCIP 822 is used, the service provider 824 may make a request 836 to the entity in the network that received the content. In one case this is SCIP 822.

The SCIP 822 sends the payment request to the D-User 814, typically through PPP 816 using the temporary identifier used when obtaining the service. SCIP 822 may want to charge some amount for its service, and the requested amount from the D-User, shown with request 838, may be higher than the requested amount by the service provider. The SCIP 822 does not have to provide the D-User 814 the amount the third party requested from SCIP 822.

As indicated, typically request 838 would go through the PPP 816 with an ID change at the PPP so that the shared data portal, SCIP is not aware of the D-User to whom the request is made.

However, in other embodiments the SCIP 822 may not be used, and in this case the service provider 824 may communicate directly with the D-User platform 812, shown with request for payment 840, which may proceed through the PPP 816 to have an ID change, and then to D-User 814.

Once either request 838 or 840 is received, D-user 814 may check the received service information and verify the payment amount due at block 850. Specifically, the check at block 850 can determine whether the service was received and the amount to be paid is the agreed amount. If transaction is agreed to, D-User 814 may request a temporary ID and an authorization code which can be used to obtain the payment from the user's financial organization with request 852. Request 852 may pass through PPP 816, which passes it to the User's financial or certification authority 820.

Request 852 provides the previously obtained authorization code and the transaction ID. The request 852 goes through the PPP 816 with an ID change and therefore, the financial institute cannot identify the P-user 810 or the D-User 814.

A response 854 with a Temporary ID and an authorization code payment is received by the PPP 816 and PPP 816 passes the codes to the D-User 814. Since the financial interaction is end-to-end (E2E) encrypted, neither the PPP 816 nor the hosting network has access to the authorization code or the temporary ID.

The D-User 814 passes a message 856 with the temporary ID and authorization code to the SCIP 822, and the payment is obtained at block 860 from the user financial institution to the hosting network (e.g. SCIP's) financial institution.

Then, the SCIP 822 may obtain an authorization code and a temporary ID from the hosting network financial institute (not shown) for the amount the SCIP 822 must pay to the service provider 824. Specifically, the SCIP 822 may keep some amount as payment for its services, and thus the two transactions. SCIP 822, in message 870, may pass the temporary ID and authentication code for the hosting network's financial institution to the service provider 824 to allow service provider 824 to obtain payment from the hosting network's financial institute.

In some embodiments, if the financial institution to financial institution transaction is considered as safe, the D-User 814 could share the authorization credentials from the user's institute with the service provider 824. However, if the SCIP 822 needs to obtain a part of the payment, the procedures shown in FIG. 8 may be needed.

In some embodiments an intermediary such as the SCIP is not needed for an anonymous negotiation between the PPP and the third party (e.g. service provider) since PPP can do the ID translation. In this case, any payment request may be made by the service provider to the D-User using the same temporary identifier used in the previous negotiation. In this case, the D-user may obtain an authorization code and a transaction ID as explained above from user's financial organization (FO) and may send it to the third party so that the third party can provide those credentials to obtain the payment from the FO. The communication with FO may happen via PPP anonymously so that the FO is not aware of who used the service provided by the third party when third party provides the authorization code and a transaction ID to the FO to obtain the payment from the D-User. The authorization code and the transaction ID may also be sent to the third party via PPP with the same temporary ID as the source so that this message would also not expose the D-User identity or address.

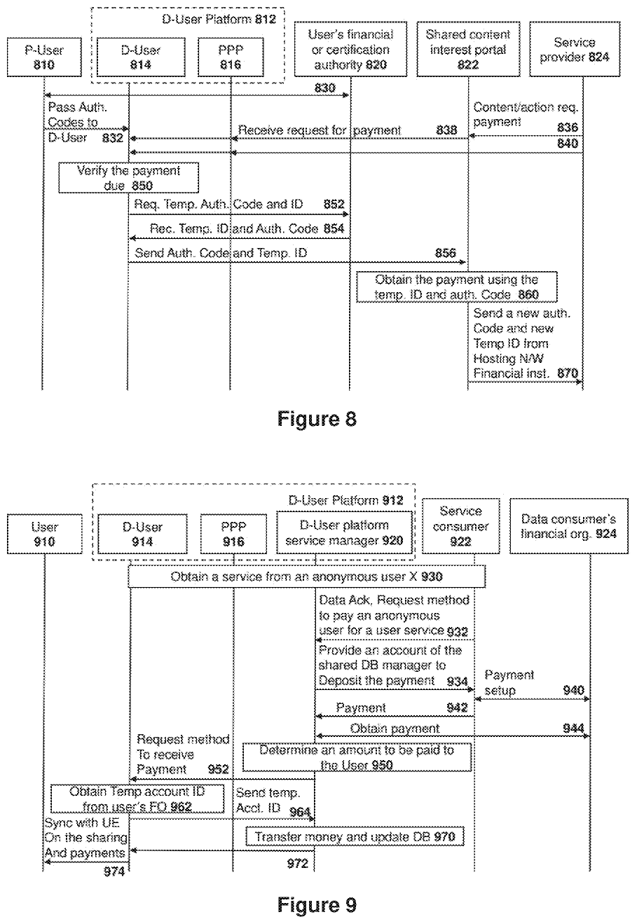

When the user wants the D-user to authorize a certain transaction on behalf of the user a similar method can be used. Reference is made to FIG. 9.

For the purpose of the D-user authorizing a certain transaction, a certificate authority should be available to certify a secure signing code for the D-user. Similarly, as a preliminary process, the user should agree with their certifying institute that the D-User can provide authorization for the user and obtain an authorization code and a transaction ID. The user may not have to provide the address, or real ID of the D-User. User can obtain an authorization credentials from the CA such that any entity sending those credentials can authorize on behalf of the user. Whenever a request is received for an agreement to be signed, the D-User, after getting confirmation from the user, would use those authentication codes and use the certificate authority to provide proof of signing. In some embodiments, a user may provide an authorization policy to the D-User specifying that the D-User does not have to get confirmation from the user for certain types of authorizations/transactions.

In some cases, this can apply to receiving a payment for an anonymous service provided by a D-User anonymously to a third party. For example, if a user shared data with the hosting network's shared data portal (SDP) to be given to the data consumers, such data consumers may want to make a payment. In that case, the D-User needs to obtain the payment anonymously as well.

In all the above transaction types, once the third party (such as a service provider or a data consumer) request is acted upon or completed, a confirmation of transaction completion is sent to the third party by the D-User or from the third party to the D-User, which indicates the closure of the action.

Thus, FIG. 9 illustrates an example of how a user could obtain a payment anonymously for a service the user provided anonymously to a third party using a D-User. It shows an example for payment reception for shared data.

In the embodiment of FIG. 9, a user 910 may communicate with a D-user platform 912. D-user platform 912 includes a D-user 914, PPP 916 and a D-User platform service manager 920. However, in other embodiments, user service manager 920 can be outside of D-User platform 912.

Further, a service consumer 922 may interact with the D-user platform 912 to obtain a service.

A data consumer's financial organization 924 is shown as being able to provide payment for the service consumer 922.

In accordance with the embodiments of FIG. 9, a service consumer 922 obtains a service from an unknown user 910 using D-User Platform 912, shown at block 930. The D-User platform service manager 920, in the network has a technique to contact the D-user 914 of the user who provided the service. In some embodiments the technique may include using a temporary identifier to the third party as the service provide ID. For example, the service could be providing user data to a data consumer as the service consumer. This data may be provided using the temporary ID or from a shared data portal (SDP) kept in the network managed by the D-User platform service manager for multiple users. SDP may have used an SDP ID/Address when sharing data. The PPP may have given a temporary ID to the SDP for ID protection. Therefore, even the SDP is not aware of whose data was shared with the data consumer.

Service consumer 922 may acknowledge the service and request from the SDP or the hosting network D-User platform Service Manager (DSM) 920, as applicable, a method to pay the anonymous user, shown with request 932.

The hosting network, using the D-User platform Service Manager 920, may provide a financial account to the service consumer 922 within which to put the payment, as shown with message 934.

The service consumer 922 may set up payment with a data consumer's financial organization 924, shown with messages 940.

The service consumer 922 may make the payment to the hosting network's financial institution, shown with payment 942, and confirm it with the D-User platform Service Manager 920.

Hosting network may obtain payment from the data consumer's financial organization 924, shown with messages 944.

The D-user platform service manager 920 may then determine how much the user 910 should be paid, as shown at block 950. As will be appreciated by those in the art, the D-user platform Service Manager 920 does not know the identity of user 910 providing the service, but merely the identifier provided by PPP 916.

The D-User platform Service Manager 920 may request from the D-user 914 a payment method, shown with message 952. Message 952 may proceed through PPP 916 to hide the identity of D-User 914.

D-user 914 may then obtain a temporary account identifier from the user's account at a financial organization using the previously obtained authorization code and transaction ID, shown with block 962, where this communication may also be via PPP so that the financial organization cannot relate the user as the entity that obtained a service, even if it obtains the service details from network's financial organization. After this, the D-User may provide the temporary account identifier to the D-User platform Service Manager 920 in message 964.

The D-User platform Service Manager 920 may then transfer money to the user's account using the given credentials, shown at block 970.

Information is shared first with the D-User 914, shown with message 972, and then with the user 910 by the D-user 914, shown with message 974 to update the user's transaction records. Message 972 may be routed through the PPP 916 to hide the identity of the D-User 914 from the D-User platform Service Manager 920.

A detailed description of how the D-User is created for the present disclosure and how the payment services described above would function is provided below.

In the embodiments of the present disclosure, the network uses a digital representative (D-User) which is a functional module created within an isolated container (a hosting platform) inside the network. The isolated platform may be exclusively used by a single D-User, shared by multiple D-Users (Multi-D-User Platform) or shared by digital representatives of other entities (D-Rep, D-Inf) etc., similar to a NET4DW platform.

A physical user usually uses a user application in the UE to interact with the web servers. The physical user (P-User) is the real entity, such as a human or animal, using or owning a user equipment (UE) which interacts with a network to obtain services from an application server (AS).

The term ‘user’ is used commonly in the present disclosure to represent one or more of a physical user (P-User), a user equipment (UE), a user access device (UAD) or user applications. The user equipment (UE) is the equipment the P-User uses to interact with the network. The UE may consist of two parts, user personal device (UPD) where all user applications, sensor information and other personal information is kept, and User Access Device (UAD) which is the device used to access the network. UAD may be a public device which may be used by multiple users.

The various sensors connected to the device may be considered as part of UPD as they carry user information. Therefore, a UE may also be considered to consist of a user access device (UAD), user applications and sensors.

The term ‘Digital User’ (D-User) is used to describe the digital representation of the ‘user’ and can be described as a digital representation of one or more of:
real or physical user (P-User) such as a human, animal, or a robot;
P-User access device (UAD);
User equipment (UE);
UE sensors; and
User application.

The term ‘D-Rep’ is used to represent the digital representation of any real entity such as a digital user, digital infra-structure (D-Inf) or a digital network (D-Net).

The description below provides further details of enclave creation, PPP functionalities and the establishment of an anonymous interaction service in the network. Using a D-user there are many other privacy preserving services can be provided.

FIG. 10 provides different exemplary types of data exchange a user can do with external entities with more details on the data sharing embodiment in this application. A privacy preserving portal 1010 is used to anonymize data and also to de-privatize data whenever applicable. The D-User C/M functions 1012 are the platform management functions which include the creation and Life Cycle Management (LCM) of the D-User functions, the coordination and access control for the functions, and resource management functions which are described below with regard to D-User creation.

FIG. 10 shows different exemplary types of data exchanges situations which include both uploading data and downloading data scenarios. In the embodiments of the present disclosure, one focus is on the data uploading or data sharing scenarios.

In this regard, procedures may first include that user data is collected into the D-User 1022. A user 1014 can purposely provide some data (Data sync function 1020) to the D-User after doing some filtering to prevent very personal data being shared, or the user may flag such very personal data with a high privacy preserving level so that the D-User 1022 can take appropriate action. For this purpose, a data synchronization channel may be established and user 1014 may be able to update data on a regular basis.

D-user 1022 may also monitor user traffic (traffic monitoring function) and gather user information. For example, this may include knowing the traffic type and the destination.

A user may also open the user data packets going through the D-User (data processing function 1030) and obtain certain data if the user allows that.

In addition, the D-User may monitor and control home equipment (data controlling function 1032) and the related data may be collected by the D-User (e.g. home equipment usage, health information). However, a user may need to provide the D-User with a privacy policy indicating different privacy preserving levels for different types of data which would be used by the D-User 1022 to take an action when sharing data.

As will be appreciated by those in the art, D-user platform may be any network server or computing device, which may in some cases be referred to herein as a network element. As such, D-User platform could include one or more processors for performing the methods herein. Further, D-User platform may include a communications subsystem for communications with other elements of the system. The communications subsystem could comprise any wired or wireless communications technology, and the present disclosure is not limited to any particular technology.

The D-User platform may further include any non-transitory computer readable medium for storing instruction code for the processor to perform the methods described herein.

Various data exchange scenarios and associated data types are described below.

### Scenario 1 Content Interests to be Shared for Pre-Fetching (Content Downloading)

The user may have to make a payment to content providers and since the content is obtained while preserving privacy, the payment should also be done preserving privacy. In addition, the D-User can also facilitate updating its content interest list (with time, priority, situation, probability, the best location to push data, etc.) with the content providers so that they can pre-push data to a provided location or to the D-User cache location.

Different types of categories of content interests may need to be considered when sharing the content interests with third parties.

Various types of data may be stored in the D-User Storage.

A first data type may include content interest storage inside D-User. These interests may be obtained from the user or gathered by observing the user activities. The interests may then be classified and stored to be shared. Example classifications include: an Authorized access category; a Public Access Category; and a Restricted content interests, among others.

The Authorized access category allows data for which content providers need user agreement/authorization for payment, non-disclosure, among other options. For example, this could include payment after a delivery to a D-User or a delivery to the end user/device.

The Public Access Category allows data for which content providers do not need such authorization. Contents with the providers can be accessed freely by the public. For example, this may include search information.

The Restricted content interests allows data for content interests that can be shared only with certain content providers who have a prior agreement with the user. A D-User may have personal content interest lists which could be accessed by a limited number of data providers with some access codes.

A second data type may include content that needs to be downloaded and stored until it is sent to the user or fetched by the user.

A third data type may include content that may be directly obtained with a query to be used by the user at a later time and that needs to be stored in the D-User.

Scenario 2: Interactions with Third Parties or Uploaded to Third Parties

In a first aspect of this second scenario, a D-User can selectively share personal data (e.g. user/device/home information) anonymously to third party data consumers for third party usage or with the network operator. A payment may be provided to the user and methods to receive payments preserving privacy, such as those described above with regard to FIG. 9, may need to be provided.

Data may be already uploaded to a D-User and waiting to be uploaded to a server in the database. This may be sent while the user is offline, as a user may have been disconnected after uploading to the D-user.

For example, this data may include home or environmental sensor information which benefits the data consumer and direct (e.g. payments) or indirect benefits (e.g., global weather information, road obstacles etc.) may be obtained by the user.

The following is a brief description of the procedure for such scenario. A user may send data to the D-User. This may be done after filtering in some cases.

Next, the D-User may provide the data to the PPP with required privacy preserving procession, sot that the data can be sent to the data consumer. For example, the data consumer may be AI4Net or any third party.

Next, the PPP may change the ID and send the data to the data consumer. If necessary, data is sent through a Full Homomorphic Encryption (FHE) module to preserve privacy, which otherwise could be leaked to an analytical entity.

Data consumers may then analyze the data and use it for their own purposes or analytical results may be provided to the users.

A second aspect of the second scenario includes user interactions with third party servers. Some interactions may involve obtaining information or content from the third parties and may involve a payment.

A D-User may pass dynamic queries from the UE to content providers via PPP by changing the queries into a privacy preserving query.

The query is sent to the D-User by the UE and D-User may pass it to the destination via PPP. PPP does the ID change and filters other personal data in the query and may specify a location to send the query results. After receiving the results, the results may be passed to the D-User and D-User would send the results to the UE.

Some queries may be done by the D-User for its own use without the query originated from the UE (e.g. for analytical purposes).

Reference is now made to FIG. 11, which shows an exemplary message flow for the anonymous query UCM service or any anonymous communication with a third party provided by the network.

In the embodiment of FIG. 11, a UE may comprise user applications 1110 and an internal User function (IUF) 1112 to process application packets sending in and out.

A D-User platform 1120 may comprise D-User 1122 and PPP 1124.

Further, a queried server 1126 for the third party entity provides different services such as responding to various queries, various search requests, various processing requests, streaming service requests and content downloading requests made by the user as in the example of FIG. 11.

In the embodiment of FIG. 11, the D-user 1122 is created and the anonymous communication service is established for the user, as shown at block 1130. These are described in more detail below. During this service establishment, a secure link is also established between the user and the D-User through which they can communicate using a symmetric key pair or an asymmetric key pair (e,g., public and private keys) only known to those two entities. A key pair for secure communication between the D-User and the PPP may also be established which also include sharing the IP addresses of each other entities.

The D-User 1122 may send parameters in message 1132 to be used to the IUF 1112 in the UE after the establishment of the anonymous communication service. Those may include privacy preserving capabilities of the network, a Privacy Preserving Query ID (PPQID) description, the D-User IP address, an ID of the anonymous service among other options.

User application 1110 wishes to interact with a third party to obtain a particular service or to provide a service, e.g., to interact with a web server (Queried server 1126) anonymously. The user application 1110 generates a data packet (Usually an IP packet) with the destination address as the address of the queried server (DDA) and one of the user application ID, USER ID or UE's IP address as the source address. The payload of the message is the message that need to be sent to the third party and it is encrypted using the public key of the third party. This is sent as query message 1140.

The original query message is modified by the IUF and generate a modified query message to be sent to the D-User. IUF 1112 may change the header of the query message at block 1142 to include the UCM type, e.g., ID of the Anonymous service (ACID) such as UCM ID) and to replace the destination address (DDA) by the D-User address. The payload of the query message is changed by adding the DDA and the privacy preserving level indicator (PPL) to the original payload so that the D-User can find the actual destination (e.g. third party) of the message although it is hidden from the network entities by including it in the payload when the message is transmitted from the user to the D-User. This DDA is hidden from the network because this new payload is encrypted using the keys which has already been established before between the D-User and UE for interactions, e.g. a symmetric keys or asymmetric keys as public and private key pairs, prior to sending the modified query to the D-User. In some embodiments the ID of the anonymous service is inserted in the new payload instead of the header. The modified query 1144 may be sent to the D-User 1122. In some embodiment modified payload may not be encrypted as indicated above or DDA may be included in the unencrypted header field and, in this case, the DDA is not hidden from the network specially when the network is trusted to know the DDA (third party). But the third party is not aware of the user or the D-User.

D-User 1122 decrypts the payload of the received message and determines modified query 1144 is a packet for an anonymous interaction service by identifying the UCM ID (e.g. ACID, remove UCM-ID and PPL, from the payload and forwards the message 1146 to PPP 1124. Before transmission of the packet to the PPP, D-User may filter the decrypted payload to remove any sensitive data in the payload and the filtered payload may be re-encrypted using the keys used for secure communication between the D-User and the PPP which is established when the anonymous service is established. In some embodiment the PPL and the UCM-ID may not be removed from the payload and kept it to be used by the PPP.

Further, the PPP 1124 may check the message, identify it as belong to the anonymous service and perform ID management where the destination address is changed at block 1148 to the web server (e.g. third party) address (DDA) and the source address is changed to the temporary D-User IP address which is reserved for this particular communication. This temporary D-User IP address is kept in a mapping table so that the receiving messages from the third party with the temporary D-User IP address as the destination can be modified to the D-User identifier (D-User address, user ID or D-User IP address) which can be found using this mapping table to send those response messages to the corresponding D-User. This is because there are many D-Users that may use the PPP for ID management. The original payload sent by the user application with the public key of the third party is kept as the payload for further transmission. PPP 1124 may then send the query to the third party after changing the source address (e.g. D-User IP address) in the header of the message 1150 to the temporary D-User IP address, which ensures that the third party does not get any information about the D-User or the user. The PPP may also indicate a temporary storage address for the third party to put the results (e.g. for a large size contents).

A payment may be needed for certain queries. In that case, payment may also be performed in an anonymous manner. In the case of a trusted hosting network, the D-User 1122 can make the payment to the Host Network Operator (HNO) and the HNO can make the payment on behalf of the user. In an untrusted case, the user may need to arrange payment with a financial organization and get a transaction ID or payment voucher and provide it to the D-User and the D-User may request the PPP to use the transaction ID to make the payment. PPP 1124 may also include a temporary location address to output the results of the query, e.g., in case of a large file such as a video.

The third party queried server 1126 may prepare the query results at block 1152 and may provide the results or response of the query in message 1154 to the specified temporary location or to the PPPm (e.g., temporary D-User address provided by the PPP 1124) (destination address) as applicable and if necessary a payment may be obtained as described above.

PPP 1124 may send the data back to the user IUF 1112 function via D-User. Specifically, the PPP 1124 may send the query results in message 1160 to D-User 1122. D-User 1122 may then send the query results in message 1162 to IUF 1112.

PPP sends the message to the D-User by changing the destination address (i.e. temporary D-User address) to the D-User identifier. In addition, the source address is inserted into the payload which is encrypted by the D-User-PPP security keys so that the network cannot correlate this message sent to the D-User as originated from the third party. This may not be needed in the case of a trusted network.

The D-User may further modify the header of the message to include the destination address as the User ID/User IP address, source address as the D-User address. The anonymous communication ID and session ID may be included in the payload and payload may be encrypted by user-D-User encryption keys.

IUF 1112 after decrypting the message, may send the results to the User application 1110 as message 1170 after changing the source address to the Query server (DDA) at block 1164. This change of source address may also be done by the PPP 1124.

Thus, according to the embodiment of FIG. 11, the user application 1110 does not have to take any special action to preserve privacy and the user application can interact with the third party as if it is connected directly with the third party although this happened anonymously to the third party.

In some embodiments, IUF functionality may be done by the user application. For that purpose, the D-user may send the parameters to the user application and user application send packets to the D-User (PPP) by including the D-User address as the destination address (i.e. The user application may be provided with the special ways of treatment of packets as that is done by the IUF so that the user application can carry out those header and payload changes). The query server address may be included in the header of the data packet as in the example of FIG. 11, and the D-User can then add the query server address to the packet as the destination address and send it to the query server. In this case, there is a risk that the user application may get information about the D-user address, which may even include security keys. Since user applications 1110 may have their connection to the related application provider, this can be a security risk. Therefore, the use of IUF function may be useful.

In some embodiments, the user application 1110 may be provided with a service type ID or an anonymous interaction service ID such as PPQID. The user application may need to include that ID inside the header and the data plane functions can detect the ID and send the packet to the D-User/PPP. However, for this purpose, the UPFs in the network may need to be updated with a new routing table.

In the case of untrusted hosting network, as described above, the D-User platform need to have a minimum number of D-Users to ensure that the ID changes are done without giving related information to the hosting network.

In addition, in the untrusted scenario, since the D-User is in an isolated enclave, the D-User can open the packets and check the content of the payload to see if any privacy leaking issues exist, as described above (e.g. filtering), and take actions.

Furthermore, the D-User can open up the packets received from the servers and carry out functions such as blocking or removing advertisements and blocking spam, among other functionality. The D-User can keep a list of such malicious third party access attempts by means of learning and feedback from the user.

A third aspect of the second scenario involves a D-User obtaining data analytic services from third parties, including the wireless network preserving privacy. The D-User may do joint analytics with the third party analytical services, including the wireless network. A user may also need to make a payment in this case.

This is similar to above Querying scenario of FIG. 11. However, in this case, a large amount of data may be sent for analysis instead of a simple query. Therefore, data filtering, for example performed by FHE is required in addition to the ID change.

This may be accomplished by a user sending data that may be analyzed to the D-User.

The D-User may then provide the data to the PPP to be sent to the analytical unit (e.g. AI4Net or any third party). A payment option is provided as in the embodiment of FIG. 8.

The PPP may change the ID and include a corresponding location to put the analytical results, and send the data to the analytical unit. If necessary, data may be sent through the FHE to preserve privacy, which can be leaked in some cases by the analytical entity.

The analytical unit may analyze the data and provide results to the specified location. Payment may be obtained as described with regard to FIG. 8 above.

The PPP may send the results to the D-User or provides access to the data area to the D-User. The D-User may then forward the analytical results to the UE.

In a fourth aspect of the second scenario, a D-User does joint analytics with third party analytical services (TPAS) including the wireless network. In this case, the user may get some payment and that needs to be arranged as well. This case is similar to the above, but there may need to be regular interactions between the D-User AI engine and the external analytics engine. Since this two-way communication happens through the PPP, a constant change of messages from D-User to TPAS has to be done by the PPP and new data (e.g., model parameters) from the TPAS may need to be sent to the D-User.

There may be other messages for state change information, etc., based on the type of joint AI analysis. However, similar procedures would follow.

### UE Functions Required for Making a Payment or Receiving a Payment

The UE may include a user application to obtain the authorization codes from financial organization. The UE may further include a user function to synchronize transactions and to check the D-user activity outcomes.

### Privacy Preserving Portal (PPP)

The functionality of the PPP is described as follows. Since D-User is deployed inside the hosting network, the privacy of the UE could be leaked to the hosting network and also hosting network information may be leaked to the UE. Therefore, several PPP functions may be used, each having different objectives as indicated below.

A first function may relate to preserving UE privacy without exposing data to the host or to the DN. One PPP function is to preserve UE data from being exposed to a non-trusted host where this function is to be provided inside the D-user. This can also be fully or partly achieved by having a PPP such as a data filter used in the UE, for example, using FHE techniques. However, this would limit the use of data for the data consumers because only a limited amount of data can be provided, and User ID or user IP address is associated with the data.

Thus, a PPP inside the D-user or a PPP in a secured location may be used for this purpose such that all the user queries, interests and other data may be shared only through this PPP. In case of having multiple D-Users or D-XX modules inside a single enclave, the PPP can also be inside the enclave. However, when a separate enclave is used for each D-User module, in order to avoid leaking privacy to the host, a separate enclave may be needed for the PPP and all the communications (outgoing and incoming traffic) to third parties which could expose user privacy may go through this common PPP.

The PPP may have the following three Core modules: a Data Portal; a Crypto Suite; and a Policy Engine.

The Data Portal may be used to provide the data processing including: Data Collecting, Data Distribution, Policy Application.

The Crypto Suite may be used to provide fundamental privacy and security functionalities, including Full Homomorphic Encryption (FHE) and Identity Management (IDM). An FHE module helps to achieve the privacy preserving query and other operations. IDM may generate and manage the Pseudo-ID which represents the D-User information. To ensure anonymity to the hosting network, there should be at least K number of D-Users inside the hosting platform, as described by K-anonymous requirements. For example, a K-anonymity model requirements can be used to anonymize user communications to/from DNs (i.e. hosting network cannot know which user inside the HOP communicated with the DN). The K-Anonymity requirement can be summarized as “for every combination of identifying attributes in a dataset, there are at least “K minus 1” other people with the same attributes”. Therefore, the source ID may need to be changed with a randomized ID and also the return address to the user may need to be randomized with a randomized location. These locations may change every time a location is used.

The Policy Engine may be used to provide an updated access policy from the User and may interact with the Crypto Suite module and Data Portal to reflect the dynamics of the User.

In order to make a payment or receive a payment, a network operator may need to first install a D-User in the network and establish the functions and the procedures in the D-User and other network functions.

The functions and procedures may involve determining different privacy requirements needed for the user for different applications and different types of interactions.

The functions and procedures may further involve, based on above privacy requirements, deciding on a proper D-User platform and installing the D-User platform.

The functions and procedures may further involve creating the D-User by instantiating the required functions inside the D-User platform. It may be better to create a generic D-user, which may be used for other D-User services other than the data sharing discussed in the present disclosure. In general, these D-User services are called User Controlled and Managed (UCM) services because the D-User can be used to manage and control any service user obtained from the network or from third party servers using the network. Data sharing can be considered as one of the UCM services.

For example, the UCM services may include: analyzing and processing user data; providing a computing platform to run user applications; providing AI services to the user; home control; financial and health control; handling data sharing with the third parties; processing user data; acting on behalf of the user; obtaining content from the third party content providers; interacting with the network to obtain a better communication service; interacting with the network to obtain network data; facilitating the interactions with third party servers such as user accessing application servers; and making payment and receiving payments, among other options.

The functions and procedures may further involve establishing the UCMS service for which the payments are involved by instantiating functions inside the D-User platform or/and the hosting network and configuring them accordingly.

Thereafter, to start the payment process, the user may need to receive a payment request or a message to arrange a payment reception method.

These functions are described in more detail below.

### Determine Privacy Requirements for the D-User Platform

When a D-user is created inside a network, it can provide many other user controlled and managed (UCM) services to the user other than the data sharing which is the focus of the present disclosure.

Some of these actions are very personal to the user, and therefore, the D-User data and operations should not be exposed to the hosting network. Such protection is not needed if the hosting network is a trusted party. However, the required trustworthiness may depend on the type of service or action the D-User is performing.

The services the D-User provides (i.e., UCM services) may be categorized into three types. In a first service type, the D-User may be acting on behalf of user by carrying out in-network processing, such as processing data, computing tasks such as running own applications, analysis and AI, controlling user devices and health, among other options.

In a second service type, the D-User may facilitate interactions with third party entities (e.g. by providing privacy, sharing data, obtaining content from the content providers, financial transactions and establishing agreements and negotiations, among other options.

In a third service type, the D-User may be interacting with the hosting network to enhance services obtained from the hosting network or third parties, for example to improve the QoS of the communication services, obtain network data and state such as loading and topology, among other options.

A hosting network operator (HNO) such as an MNO can decide what type of D-User may be created based on the services it needs to provide to the user and the privacy requirements.

A D-User may need to be isolated from hosting network depending on the trust level the hosting operator would like to offer. For example, there may be a need to avoid the possibility of accessing user data by the hosting network. In addition, a D-User may need to be isolated from the external networks the user may access. Further the user may need to be protected from malicious attacks to avoid the possibility of accessing user data by the hosting network.

The hosting network can provide these services as a trustworthy party to the user or an untrustworthy party. Table 1 provides some example privacy preserving levels a user may require for different types of UCM services. In order to meet those requirements, the D-User may be instantiated inside a network module isolated from the network, which is termed as a ‘Hosting Platform’ (HOP) herein. The required level of isolation depends on both the trustworthiness of the hosting network and the type of UCM services the D-User is providing to the user. In addition, the HOP may help a user to preserve privacy when the user accesses external servers.

Depending on the isolation requirement different solutions are possible. The complexity and/or the cost of providing a D-User may depend on what level of trust the host would provide.

These cases are summarized in Table 1 below.

In Table 1, a trusted network (T) means a user needs to trust the network which provides the particular service/capability to the user. On the other hand, an untrusted network (U) means a user can obtain the service from the network preserving privacy without leaking user information to the network which provides the service.

TABLE 1
Example levels of privacy that can be provided by the network for UCM services

| | Exposure to hosting network & | | | | | | | | |
|---|---|---|---|---|---|---|---|---|---|
| | Trustworthiness (T/U) | | | | | | | | |
| | | | C/M | | Exposure to External data Network | | | D-User | |
| | | Data + | Operation/ | Destination | (e.g. Server) & Trustworthiness | | | capability/ | Requirement/ |
| Use case | T/U | Processing | Action | Address | T/U | Data | User ID | UCM service | Solution |
| 0 | U | No, | Yes | Yes | T | Yes | Yes | Network provides | Current system. |
| | | Encrypted | | | | | | transport service. | No privacy solution |
| | | | | | | | | | other than UE |
| | | | | | | | | | filtering. |
| 1 | T | No, | Yes | Yes | U | Yes | No | Can access third | ID change by the |
| | | Encrypted | | | | | | party servers | host. A container |
| | | | | | | | | anonymously. | needed for D-User. |
| | | | | | | | | Payload not | |
| | | | | | | | | accessible to the | |
| | | | | | | | | host. | |
| 2 | T | Yes (PPP) | Yes | Yes | U | FHE | No | User data can be | ID change and data |
| | | | | | | | | processed inside | de-privatized by |
| | | | | | | | | the network (data | host. |
| | | | | | | | | accessible to host) | Data processing |
| | | | | | | | | as needed and | done by host. |
| | | | | | | | | share data with | D-User |
| | | | | | | | | third parties | in a container. |
| | | | | | | | | anonymously. | |
| | | | | | | | | USER ID change | |
| | | | | | | | | and data de- | |
| | | | | | | | | privatized by host. | |
| 3 | U | No | Yes | Yes | U | FHE | No | D-User can | User data is not |
| | | | | | | | | process data. Host | accessible to host. |
| | | | | | | | | does not have | |
| | | | | | | | | access to user | |
| | | | | | | | | data. | |
| 4 | U | No | Yes | No | U | FHE | No | Can access third | HOP needs to have a |
| | | | | | | | | party servers | minimum number of |
| | | | | | | | | anonymously and | D-Users (multi-D- |
| | | | | | | | | share data | User platform). HOP |
| | | | | | | | | anonymously | changes the USER-ID |
| | | | | | | | | without the host | and de-privatized |
| | | | | | | | | knowing which | data. HO in an |
| | | | | | | | | user accessed the | enclave. |
| | | | | | | | | third party server. | |
| 5 | U | No | No | No | U | FHE | No | Same as above. | The operations |
| | | | | | | | | Host does not | inside the HOP are |
| | | | | | | | | know what | done direct control of |
| | | | | | | | | actions user is | user and host is |
| | | | | | | | | taking inside D- | unaware of them. |
| | | | | | | | | User. | HOP in an enclave. |

As shown in Table 1, the following one or more following techniques are used to keep privacy: (1) Keeping HOP in an enclave; (2) HOP carrying out ID change; (3) HOP in an enclave and contain a minimum number of D-Users to do ID change anonymous to the hosting network; (4) HOP does the data de-privatization, for example using FHE.

The embodiments of the present disclosure focus on providing methods to share data with third parties, preserving privacy. The solution is provided for both trustworthy networks and untrustworthy networks.

The HOP requirements and solutions for the cases indicated in Table 1 are further described below.

Existing (current) mobile networks have No D-User, no privacy from third parties. Current mobile networks act like a transport system for the user to access the external data networks/servers. Data is end-to-end encrypted so only the user device and the application server have access to data and control of data. A user can filter the data they share with the third parties but, depending on the service they obtain, they may have to provide their IDs with their valuable information. In addition, a user does not have any control or management of the services the user obtains from the network (i.e. no UCM service can be operated)

Use Case 1: This use case provides anonymous access to third party servers. The service providing network needs to be trusted in this use case.

A mobile network hides the user identity (ID change) so that a user may access the external servers anonymously. The network is trusted to keep access sites/server descriptions private, other than for police tracking events.

For this use case, a requirement is that the external server does not know which user accessed it. To solve this, a host may use an ID Management Function (IDMF) to change the source ID and also change the return address. However, in this case a host knows what server the user accessed, which may be a privacy leak to the host.

The HOP can be an isolated network function module created using the hosting network infrastructure in this case.

Use Case 2: this use case involves network aware in-network processing, where a D-user exposed to the trusted network may be used.

Processing data inside the network enables many services to the user, such as AI services or service optimization solutions. The network can provide these services, but at the risk of data and processing details being exposed to the host.

This use case requires the network to provide a data processing function (PPP) for the user. To solve this, a host may provide a PPP for the user. User data (payload) is exposed to the host. The network can additionally provide a user ID change similar to Use Case 1 to protect the user identity from the third parties, but the host would know both the external server address and the payload.

In this use case, the HOP can be an isolated network function module created using the hosting network infrastructure.

Use Case 3: this use case involves a network that is unaware of in-network data processing, and may use a D-User isolated from the untrustworthy hosting network.

Unlike in use case 2, user data can be processed inside the network without exposing the user data to the host. Anonymous access to the third party servers can additionally be provided as in use case 1. However, the host would know the external server address.

For this use case, a requirement is that the network needs to provide an isolated data processing function (PPP) inside the network to the user and an ID change function to access external servers anonymously. To solve this, the host may provide a PPP or a D-User inside an isolated enclave.

The HOP can be an isolated enclave in a confidential computing environment.

Use Case 4: this use case involves access to third parties anonymously (network unaware) and the use of a D-User isolated from untrustworthy hosting network.

Anonymous access to the third party servers may be provided without exposing external server address to the host. In addition, host-unaware in-network data processing can be done similar to use case 3.

This use case requires a network to provide an isolated IDMF (not accessible to host) inside the network to the user. To solve this, a host may provide an IDMF inside an isolated enclave. However, in order to carry out an ID change without the knowledge of host, a minimum number of users should use the isolated enclave, e.g. Multi-D-User platform. In addition, a host can do in-network processing inside the enclave as in Use Case 3.

The HOP can be an isolated enclave in a confidential computing environment which can create at least a K number of D-Users as such that the K-anonymous requirement described in L. Sweeney. “k-anonymity: a model for protecting privacy”. International Journal on Uncertainty, Fuzziness and Knowledge-based Systems, 10 (5), 2002; 557-570 which is hereby incorporated by reference in its entirety. The HOP should have a minimum number of D-Users. For example, the K-anonymity model requirements can be used to anonymize user communications to/from DNs (i.e. hosting network cannot know which user inside the HOP communicated with the DN). The K-Anonymity requirement can be summarized as “for every combination of identifying attributes in a dataset, there are at least “K minus 1” other people with the same attributes”. Therefore, the source ID may be changed with a randomized ID and also the return address to the user may be randomized with a randomized location.

Use Case 5: this use case involves network unaware operations by the D-User.

This case is similar to use case 4, but additionally, the host is not aware of the type of operations the user does for its services. Thus, services the user obtained are agnostic to the host.

This use case requires a network to provide an isolated data processing function (PPP), an isolated IDMF and the entire user service functions to be inside the HOP. To solve this, in addition to above use case 4, the D-User related functions are completely placed inside the multi-D-User platform. For example, the D-User related functions may be a separate slice for the multi-user hosting platform. Once the HOP is created, the HOP may be given the capability of independent operation. For this purpose, when the HOP is created a HOP manager function (HOP-M) is created inside the HOP, which can do the LCM D-Users (e.g. creation, modification and termination of D-Users) and common functions needed for the interaction of the D-User functions with entities outside the D-User (e.g. other platforms inside the HOP, hosting network functions, P-User and P-User devices, third party servers), and include privacy preserving functions when a D-User is communicating with external entities.

For this use case, the HOP can be an isolated enclave in a confidential computing environment.

In above use case 1 and use case 2, the network can provide the UCM services described using an infrastructure managed and controlled by the host, which is less complex and less costly. However, user privacy is exposed to the host.

In use cases 3, 4, and 5, different UCM services can be provided by using a D-User installed inside the host network without user functions or user data being exposed to the network according to the privacy requirements for those cases.

Therefore, there are at least two options for a network operator to provide a D-User service.

### Hosting Network Provides D-User Service as a Trustworthy Entity (Use Cases 1 and 2)

In this case, only the users who can trust the host would like to get a service which limits the hosting network's ability to serve the general public. The host does not need to provide strict isolation with the hosting network, although it has to provide full protection to the user data and operations against exposing them to external entities who interact with the D-User or user, such as data consumers, servers among other options.

In addition, D-Users may need to be isolated from each other to protect privacy. Furthermore, access to functions inside the HOP may be access controlled using a GW in the C/M plane and a GW in the DP plane. The hosting network could use its own infrastructure to create an isolated software container (a platform) for the D-User and the host does not need to provide a TEE including hardware isolation since host is trustworthy.

A container is a standard unit of software that packages up code and all its dependencies, so the application runs quickly and reliably from one computing platform (hosing platform).

Host Provides D-User Services as an Untrustworthy Network where Users do not have to Trust the Hosting Network (Use Cases 3, 4, and 5)

In this case, the host may provide added actions to isolate the D-User from the host's own network. Therefore, a HOP may need to be created inside a confidential computing environment created inside the hosting network, such as a TEE. The HOP may further be pre-configured to be able to create the necessary functions inside the platform and interact with the users. In this case this hardware platform may be created with a platform manager inside the HOP, which is able to create the other functions and the required interfaces for those functions.

In both cases, the D-User modules may be isolated from each other and also privacy preserving techniques may need to be established when accessing the external servers. Isolation from the hosting network is required for use cases 3, 4 and 5.

### D-User Types and UCM Service (UCMS) Types

As described above, there are numerous UCM service types that a D-User can use. Depending on the UCM services a D-User is supporting, a D-User's composition can be different. Thus, it is desirable that D-Users are classified according to the types of UCMS services they can support. Note that a UCM service is a service a user receives to control or manage its services or network entities providing the service. A D-User may consist of one or more functions that may be needed for UCM service provisioning.

D-Users and a user needing a UCM feature would subscribe to the associated D-User type or to a UCM service. Not all users need user empowerment and therefore a D-User is provided as an add-on feature to a user on an as needed basis. When a user requires the feature, the user may make a special request to the network, which is forwarded to a D-User creation function in the network.

The types of D-Users or types of UCM services may be standardized for the UE to request the required service. An MNO might provide the D-User facilities based on its view on creating these functions and associated privacy preserving methods, costs and available facilities.

The UCMS services can be grouped such that they can be supported by a common set of functions or common network topology.

Table 2 below shows an example categorization of D-User types and associated UCM services based on the basic functions that are needed for a D-User.

TABLE 2
Example D-User type categorization based on common functional requirements

| | | UCMS service that | |
|---|---|---|---|
| D-User | Basic UCM services (UCMS) | can be provided | |
| Type ID | supported | with minor additions | Comments |
| Type 0 | User can create any UCMS | Any UCMS service | |
| (basic | services by adding | | |
| D-User) | functionality | | |
| Type 1 | UCMS 2: authentication of | UCMS 3: Making or | Need key exchange |
| | user for service access, | receiving payments | with core network |
| | authorization for using | to/from third party | functions and CA. |
| | personal data, payments | preserving privacy | Need UE home |
| | UCMS 1: Home network, | | equipment |
| | equipment health and | | controlling |
| | alarm control | | functions and |
| | | | storage |
| Type 2 | UCMS 4: Capability to | UCMS 6: | D-User needs |
| | dynamically obtain special | controlling UE | access to RAN and |
| | network features for its | traffic routing | request resources/ |
| | dynamic needs (e.g. low power | within the network | features (dynamic |
| | channels, diversity). | UPFs | CPF interaction |
| | UCMS 5: Capability to define | UCMS 7: obtaining | with 3GPP at |
| | special services (e.g. QoS | service quality | L2/L1). No UPF. |
| | guarantee over a specific route, | maps | Need resource |
| | multiple channels | | control for UCMS3 |
| Type 3 | UCMS 8: Ad/Spam blocking | UCMS 9: TCSP | Application level |
| | UCMS 11: Source address, ID | acceleration with a | protocol stack at D- |
| | change for privacy | proxy | User. Need CPFs |
| | UCMS 12: sharing content | UCMS 10: local | and UPFs and data |
| | interests | data caching and | processing |
| | UCMS 14: Processing specific | pre-fetching | |
| | user traffic | UCMS 15: sharing | |
| | UCMS 16: Support for UE's | data | |
| | Net4AI applications | | |
| Type 4 | UCMS 17: obtain own network | | Need RAN |
| | resources/services (slices, | | capability info and |
| | tunnels, multiple AP | | resource control |
| | RBS/frequencies | | |
| Type 5 | UCMS 18: D-User AI | | Joint network |
| | interaction with UE and | | optimization |
| | network AI to optimize | | capability |
| | network and UE services | | |
| Type 6 | UCMS 19: Obtain service from | UCMS 20: Supporting | Interacting with |
| | neighbor UEs and vice versa | network for XaaS | neighboring UEs |
| | (e.g. relaying, D2D) | services | infrastructure, |
| | | | providing services |

As for example shown in Table 2, certain UCMS types does not need UPFs inside the D-User for special processing and the D-User is simple. In this case too there is no exposure of raw data (e.g. D-User Types 2, 3, 4, 7). In addition, there are certain UCMS services which do not need network exposure information. This also reduces the complexity (e.g., D-User Types 1, 4). Another D-User categorization may be that certain UCMS types do not need the exposure of user information to the network, which may relax the privacy requirements (D-User Type 1).

The following is a further description of the example D-User categorization.

Basic/Default D-User which is Able to Establish New UCM Services (Type 0)

In some embodiments, an HNO may decide to establish a basic or default D-User which can later be extended to provide any UCM services or any D-User type that a user requires. Creation of a basic or default D-User enables the network or user to create UCM service on an on demand basis. Therefore, any other D-User type can be considered as a basic D-User modified by adding functions to support specific UCMS services.

For this purpose, a basic D-User has a logical control link established between the UE and the D-User. The D-User has one or more functions to create additional functions required for a UCM service when requested by the user or a network function. The one or more functions may include functions to trigger the creation of a D-User from a network function orchestration function or an equivalent management function.

D-User Having Only CPFs and Storage and does not Need Network Exposure (Type 1)

This is the simplest D-User, which has only control plane functions and no user plane functions. It may need storage to keep information related to the user, e.g. user context. It can have one or more control plane functions. The one or more control plane functions may include a function to communicate with the user, for example to obtain user requirements. It may also include a function to communicate with the control plane functions of the hosting network.

Additionally, the D-User can have a function to control the UPF functions, which depends on the type of the UCM service the D-User intended to provide.

The following are some of the UCM services this type of a D-User can provide.

A first UCM service involves the D-User taking decisions for home equipment, personal health and to trigger alarms to a Personal User Device (PUD) or external home/health control systems.

A second UCM service involves authenticating and authorizing on behalf of a user when interacting with third party entities.

A third UCM service involves making payments or receiving payments to/from third party entities without providing identification to them and without allowing the financial institution to know the receiver or provider of the payment.

Other UCM services are possible.

### D-User Having Only CPFs and Storage and Use Network Exposed Features/Facilities (Type 2)

This D-User type, in addition to having CPFs, may be provided with capabilities to obtain certain type of network information such as specific facilities provided to UEs. For example, this may include specific processing or traffic routing control, priority control or application of special technical features of the MNO (RAN/CN), topology or traffic monitoring, such as loading situations and costs in dynamic costing situations.

A UE may request special network features dynamically for its dynamic needs, such as low power channels for example.

The situations may define special services/flows for efficient communications. These may include a specific QoS for multipath diversity combining for uplink or downlink. These may include a rate QoS guarantee for a UE moving path. These may include a specific service which may consist of a combination of flows with a specific QoS requirement.

The situations may define a UE controlling its own traffic insider the MNO.

The situations may allow a UE to obtain geographical areas with good service quality (map), knowing that the UE can move to good locations or routes.

### D-User Having UPFs for User Traffic Handling and Controlling User Data (Type 3)

This D-User type allows the user to process its traffic according to its own processing functions. It also allows the user to do data processing that is agnostic to the network or carry out network agnostic communications with DNs.

The following are some example UCM services.

A first UCM service allows the UCM to work as a middle person to block ads, which may also reduce the air interface bandwidth.

A second UCM service allows the UCM to work as a proxy to do application and/or Transport control protocol (TCP) acceleration. It further provides the capability to provide user dependent QoS requirements for a given application by adjusting the user QoS and monitoring the service quality experienced by the user.

A third UCM service allows local data caching and pre-fetching.

A fourth UCM service allows privacy preservation when querying or accessing third party services with a different user ID.

A fifth UCM service allows sharing content interest for pre-fetching.

A sixth UCM service allows the D-User to receive data, such as voice recordings for example, when the user is offline.

A seventh UCM service allows the processing of specific types of traffic, transparently to the network.

An eighth UCM service allows the sharing of user data with third parties and the network.

A ninth UCM service allows the analyzing of user data (e.g. Net4AI) an running user applications.

Other UCM services are possible, and the UCM services described above are merely provided for illustrative purposes.

D-User has its Own Resources Obtained from the Network which can be Controlled or Managed by D-User (Type 4)

For this D-User type, resources such as certain network segments (RAN or CN parts), network slices, transport bearers, AP resource blocks, APs, reflective intelligent surfaces (RISs), among others, can be obtained exclusively for a user and may be used for the user's own traffic.

D-User Capable of Joint Network Optimization by Communicating with MNO (Type 5)

For this D-User type, a user can support the network services and vice versa by, for example helping joint optimizations or supporting network services. This may include D-User AI interaction for joint design providing predicted user information (e.g. mobility prediction for resources and tracking area, per UE based UE idling time, user switch off or volume turned down, among other options.

### D-User Capable of Supporting Network Services (Type 6)

Under this type of D-User, a user can support the network services and vice versa by, for example helping joint optimizations or supporting services, some of which are described below.

In a first service, a D-User can ask a UE to facilitate network traffic to UEs neighbors or vice versa (knowing neighbors from the network).

In a second service, a D-User may support network to deliver non-connectivity XaaS services, including but not limited to AI services, Video/weather sensing data from D-User, among others.

Other services are also possible.

### Creation of the D-User Platform

As described above, in order to provide UCM services, a D-User module may be created inside a network with required functionalities. D-User functionalities may be isolated based on the type of UCM service being used by the user. Therefore, a D-user may be created as a container or a software module inside a hosting network.

A container is a standard unit of software that packages up code and all its dependencies, so the application runs quickly and reliably from one computing platform (hosing platform).

Containers can run on the same operating system (OS), which provides weak isolation from each other and also from a hosting network. In this disclosure, the term ‘software container’ is used for such a container. There are additional protection methods to secure some of the features from the other containers in the same computing platform, but a software container cannot be fully isolated from the host.

An enclave is a container which provides hardware isolation in terms of having a protected memory region that provides confidentiality for data and code execution. The enclave an instance of a Trusted Execution Environment (TEE) which is secured by hardware. Therefore, it is referred to as a hardware container in this document. An enclave can also be run on its own CPU separate from the CPUs used by the network. An enclave can also be considered as a virtual machine (VM).

Therefore, the D-User hosting platform (HOP) can be created using a software container or a hardware container (an enclave) based on the privacy level required.

With regard to a software container, the HNO may use its own infrastructure and creates an isolated software container for the platform. In this case, the internal function creator may not be inside the platform, but a platform manager can manage the Network Functions (NFs) and associated resources using proper Application Programming Interfaces (APIs). Without hardware isolation this may not be the preferred option by the users in some cases.

With regard to an enclave, the HNO may use an enclave such as a trusted executive environment (TEE), which is pre-configured to be able to create the necessary functions inside the platform and interact with the users. In this case, this hardware platform may be a standard platform with a platform manager, which is able to create the other functions and the required interfaces.

When the HNO decides to provide D-User services, the HNO may first create a HOP platform with a HOP manager which is capable of instantiation of the D-User portals when requested by the HNO CPFs or HNO's D-XX service manager (DSMF). The HOP platform may be created inside the HNO network but isolated from the network so that the hosting network cannot access user data inside this platform.

Some HNOs may not use a common HOP such as a NET4DW or Multi-D-User platform to create D-Users and may create a platform exclusively for an individual D-User. Therefore, a hosting platform (HOP) can be an exclusive platform for a single D-User, a platform for multiple D-Users (Multi-D-User Platform) or NET4DW platform which can have D-User modules, D-Rep modules or any application server such as a digital world (DW).

If each D-user is created inside a separate enclave, a separate D-User manager (D-user-M) as described below may not be required, and all the D-User-M functions described may then be done by the Host Management Function (HMF).

### Creation of a D-User

Establishment of a D-User inside a HOP may be initiated either by a user, a network entity, a third party service provider, a third party D-Rep inside the HOP or another D-User of the same user, among other options.

Different HNO's may offer D-User and UCM services to users in different ways. In addition, a network entity may create a D-User on special occasions (e.g. handover). Furthermore, external services such as DW services or D-Raps may request the creation of a D-User for which user authorization has already been obtained.

The following are some of the example implementations an HNO may consider offering to users to create a D-User and obtain UCM services.

A first option may include D-User creation with a subscription. An HNO may require a user to first subscribe for a service with a D-User service management layer function (DSMF). After subscribing, the DSMF may take an action to create the D-User. The subscription may be for one or more of a basic D-User, Specific D-User type(s) which can provide certain UCM services, specific UCM service type(s), among other options.

Subscription for different D-User types may incur different charging systems for the service.

Further, subscription for a UCM service without having a D-User may be interpreted as a subscription for both a D-User and the specific UCM service.

Subscription for a basic D-User may not facilitate any UCM service, but there are at least two ways to obtain a UCM service after subscription for a basic D-User. These may include that the user has to subscribe for a specific UCM service in some cases. They may further include that the user can request to add a UCM service dynamically, making such a request to a D-User control plane function (D-User creation function (DUCF)). In this case, the D-User can quickly orchestrate the service by instantiating and the configuring the required functionalities as the basic D-User is in place.

A second option may include dynamic D-User creation with a request to a control plane function. A user, third party service operator, a third party D-Rep inside the HOP, or a network entity may trigger dynamic D-User creation by making a request for a specific D-User type(s) or a UCM service type(s) from a control plane function (DUCF).

In this case, some HNOs may need a prior subscription for a D-User and the HNO may design and prepare to create a D-User at subscription, but the HNO does not create a D-user until such a request is received through the DUCF.

Further, some HNOs may consider such request as a request for a subscription and creation. Therefore, the DUCF may take an action to add the user subscription for a D-User type or UCM service type and initiate the creation process. Subscription is needed to start the charging mechanism and its associated monitoring system.

A third option may include dynamic D-User creation with a request to a HOP function. In this case, a user or network entity may directly request a HOP function which is capable of creating a D-User or UCM service without requiring the authority from the hosting network. However, the HOP function may have obtained prior authorization from the network for such creations. The subscription for such services may be kept inside the HOP. An in-network DW may create individual D-Users or D-Reps in this manner.

A fourth option may include D-User creation by a third party service provider from a service management layer. In this case, a third party service provider may not typically have access to make a request to control plane function as in above second option. In such case, the third party service provider has to first make an agreement with the HNO and the HNO may want to obtain user authorization for the same. An external DW operator or XR operator may need such a service.

In a further embodiment, different types of D-Users or a basic D-User may be created beforehand, and when a request comes they are allocated to the users with some modification, including function configuration which may speed up the creation process. This may be applied to all above cases, in which case the creation procedure in the options above means assignment of an already created D-User to a particular user with certain configurations.

These configurations may include establishment of a secure link between the user and the D-User and specific user policy transfer from the user to the D-User and HOP managers.

Additionally, specific techniques for the privacy requirements of a particular user may be established. The number of D-User modules to be kept in this not-connected, deactivated mode depends on the arrival pattern of the new D-User requests. Multiple D-Users may be kept inside a single HOP or each D-user may be allocated a HOP.

Methods to Create a D-User with Different Isolation Requirements

The following embodiments are provided to address different privacy requirements discussed in the previous usage scenarios.

D-Users should be isolated from D-Users of other users, but they can share the same network functionalities. This is true for all the use cases 1 to 5 described above. In this case, the D-User can use a software container providing added functionality to isolate the D-Users of different users from each other. When a user uses multiple D-Users, it may not be necessary for the D-Users of the same user to be isolated from each other, and the D-Users may share common functions for their operation.

A HOP may be created inside an enclave isolated from the hosting network. In other words, even the hosting network should get permission to access functions or data inside the enclave. This may be needed for use cases 3, 4, and 5 described above. For this, an isolated confidential computing platform such as a TEE may be used.

A HOP platform may need to be used for multiple D-users in order to do ID changes to hide the identity even from the hosting network when communicating with external devices. This may be needed for use case 4 described above. For this purpose, the HOP should keep a minimum number of D-Users inside the HOP. For example, the K-anonymity model requirements referenced above can be used to anonymize user communications to/from DNs (i.e. hosting network cannot know which user inside the HOP communicated with the DN). The K-Anonymity requirement can be summarized as “for every combination of identifying attributes in a dataset, there are at least “K minus 1” other people with the same attributes”. Therefore, the source ID may be changed with a randomized ID and also the return address to the user may be randomized with a randomized location. Additionally, the same privacy requirements can be achieved by having minimum number of D-users, each in separate enclaves. Egress ports (and ingress ports) of all the enclaves to third parties may go through another enclave isolated from the host to do the random ID changes and to hide the D-Users from the third parties.

Once the HOP is created, the HOP should be given the capability of independent operation. This may be needed for use case 5 described above. For this purpose, when the HOP is created, a HOP manager function (HOP-M) is created inside the HOP which can do the LCM D-Users (e.g. creation, modification and termination of D-Users) and common functions needed for the interaction of the D-User functions with entities outside the D-User (e.g. other platforms inside the HOP, hosting network functions, P-User and P-User devices, third party servers), privacy preserving functions when a D-User is communicating with external entities, among other functions.

### D-User Creation Procedure

As discussed above, when a request is made by a user, a network entity, or a D-Rep, to create a D-User, the request may be received by the hosting network service management function (DSMF) or a control plane function, (DUCF-D-User creation function), depending on the specific implementation an HNO provides to its customers. A request to DUCF is a request for a dynamic creation of a D-User.

The user request may be made using a subscription to a customer service department (CSD), which may be sent to DSMF to initiate the creation. In other cases, the request can be made dynamically using the UE control plane trigger to the control plane function, DUCF. In addition, a user application inside the DU can subscribe directly to DSMF. There are several subscription options a HNO may provide for the user.

In a first option, the HNO may provide for subscription for a D-User service, where the network creates the D-User. Further the HNO may provide for subscription for a UCMS service, where the network may add UCMS functionality to the D-User.

In a second option, the HNO may provide for subscription for a new UCMS service, where the network creates a basic D-User if there is no existing D-User and may add new UCMS functionality to the D-user.

In a third option, the HNO may provide for a subscription for both a D-User and a UCMS service (or a specific D-User type providing the UCMS services). The network may create a basic D-User and add UCMS functionality.

Once a subscription for a D-User occurs, this may be included in the user subscription repository (UDR) controlled by a user subscription manager (USM). Then, when a user wants to establish or use a UCMS session, the network may check whether the user is authorized by checking the UDR. For this purpose, the D-User service provider may publicize or provide the user with all the information of the D-User services, various methods for subscription and associated policies, which may include charging policies and privacy policies.

After receiving a subscription, the hosting platform may create the required D-User with a D-User manager (D-User-M) and access control function. The D-User-M is given security credentials to establish communication with the user (address, security keys etc.). A user is also provided with the required information to establish the logical communication link. A secure communication link may also be established for the D-User-M to contact the HOP manager. A D-User access control function may authenticate and authorize the access of the internal functions by external functions. As discussed above, a D-User can be created inside an enclave or a software container. These options are discussed below in detail.

Case 1 D-User is Created Inside an Enclave (e.g. Using a TEE)

In this case, first the D-User-M is created and may establish a secure communication channel with the UE. The D-User-M may be provided with the capability to instantiate the NFs required for the authorized UCMS services for that D-User and other LCM functions without the knowledge of the hosting HNO.

The HNO may charge for the UCMS services using the information it obtains from D-User-M about the services provided or resources used. The HNO can be based on one or more of the resources used, the type of services used, types of applications run, or the amount of traffic that is sent in and out of the D-User (for each type of QoS). Therefore, the D-User-M is created inside the TEE with the capability to provide that information to the HNO. If a user does not want to provide service information to the hosting network, the charging of the HNO may be done based on the resources used for the D-User. In addition, the D-User-M carries out the resource management for different UCMS services.

There are at least two options to create a D-User inside an enclave. One option is to install an enclave exclusively for a D-User. Another option is to install an enclave for multiple D-Users. An important aspect of using an enclave is the capability of the user of the enclave to attest to the credibility of the enclave functionality. Specifically, a user can be assured that the enclave cannot be accessed by the hosting network.

If a single user is using the enclave, the remote attestation is straight-forward as the access codes are given by the vendor before the installation. The hosting network has to provide access to the user once the D-User is created with a D-User-M and optionally with an access control function. These original functions codes are hard-coded by the vendor and, therefore, a D-User can create a remote attestation code, which may be a hash value of the current network functions inside the enclave and may be provided to the user with the vendor address and authentication keys.

A user can validate this hash value by sending the hash value to the vendor directly to do the remote attestation and vendor may attest it and send the certificate to the user. The original functions may be provided to the vendor by the network operator and the codes may be verified to not allow a third party to access other than using the access code provided by the vendor. The original functions may also include blueprints of the initial D-User and various UCM services which makes the D-user self-sufficient to provide the UCM services.

If multiple D-Users are to use a single enclave, the remote attestation may need to be done very carefully, as a user needs to guarantee that the hosting network cannot access the functions inside the HOP and the D-User after creation. In this case, the original HOP-M has the capability to create D-User modules for different users. In some embodiments, the D-User manager's original code provides the D-User manager with the capability to create a D-User and provide a default D-User-M program and, in addition, provide a separate executive environment, a separate memory area and an access code to access the D-User-M. A user may have remote APIs carry out specific functionalities such as creation of the functions within the D-User. The user can also run its own applications inside the protected area by installing new software, but any attempt to access outside the allocated memory area may be prevented by the HOP functionalities. Since HOP functionalities cannot be modified, the remote attestation will still guarantee the protection of the D-User activities from the hosting network as from other D-Users inside the enclave. Access to these areas is controlled by the original code of the HOP, which can be remotely attested by each user. The issue here is that each user has the same remote attestation code. However, since they cannot alter the original HOP program codes, this is not a vulnerability.

In some embodiments, the remote attestation for HOPs with multiple D-Users can be done by providing a separate remote attestation code for each user for its D-User functionality. In this case, the HOP original program code has the ability to create a default D-user in a separate container inside the HOP when requested by an authorized user having an access code, for example the hosting network function. The default D-user is created according to the vendor specifications. At this point, D-User access is provided to the user and user can obtain a remote attestation code for HOP and D-User codes separately.

A user can do remote attestation with the vendor at this point to obtain the certificate for isolation. Any modification of the functionality, interface or configurations after this point needs to be carried out with the authority of the D-User-M only. A D-User can obtain instructions only from the user for this purpose. In other words, neither the HOP nor any network functions in the HN can modify any of the functions or configurations inside the D-User module without the knowledge of the user and without the user authorization. Such modifications (function creation, function configuration, interface establishment etc.) are kept in a log inside the D-User and also a similar log is kept with the user. This way, a user can, from time to time, attest that the D-user functions are not modified without authority and also that the D-User is fully under the control of the user.

When preparing the code for remote attestation, the D-User can include all of the changes or, after excluding the changes, may inform the user the method that is used. The user uses the same method to attest the D-User configuration.

Once the D-User is established with the required functions and interfaces, the UCM service can be established dynamically as requested either by the P-User or a network entity.

Case 2: D-User is Created Using the HNO Infrastructure within a Trusted Environment

Once the HNO decides to create a D-User (e.g. after UE subscribed for a D-User/UCMS service), an Operations Administration Maintenance (OAM) function, D-User network orchestrator (DUNO), in the HNO may be triggered. DUNO creates a D-User-M function and associated NFs and required interfaces to the Core Network (CN) network functions. If the D-User needs to be created with UCMS services, the functions may include the basic D-User functions as well as functions required for the UCMS services which can include both CPFs and UPFs. This is similar to a subnetwork in 5G with CPFs.

The interfaces include a synchronization (sync) channel between the UE and the D-User. The sync channel could include a signaling interface. Additionally, depending on the D-User/UCMS requirements, one or more data channels may be set up.

The D-User-M may be provided with the UE identification and authentication methods. Setting up the sync channel includes the HNO providing both UE and the D-User-M the security keys, UE identification (this may be different than the UE ID) and address information. After that, the UE may set up its own security keys for communication with the D-User.

In some embodiments, the D-User-M has given the authority to create CPFs and UPFs. A proxy Virtual Network Function Manager (VNFM), and a proxy Virtualized Infrastructure Manager (VIM) is provided, and an interface is provided with the Digital User Network Orchestrator (DUNO) for this purpose.

The lifecycle management of NFs may be done by the D-User-M or the DUNO.

The message flow for D-User creation and UCMS service establishment for both of above case 1 and case 2 are provided below. The enclave or container preparation is excluded from this description for clarity.

The HNO's customer service department (CSD) provides a description of the available D-User and UCM service to the public. This description may be provided by broadcasting the information to UEs in some cases, or users may obtain this description by requesting it in some cases. In some cases, a user may access the information from other sources (e.g. from the HNO's web site). Information may include service descriptions such as privacy levels and user processing facilities, charging methods for different types of services, among other information.

A P-USER may subscribe for a suitable one or more of D-User type or UCM service type with CSD. This may be for a basic D-User subscription as explained below. The CSD may inform of the subscription to the D-XX service manager (DSMF).

CSD may then confirm the subscription to the P-User with charging (fee) information.

Optionally, a user application can contact the DSM to subscribe for a D-User or UCM service type.

Further, optionally a network entity may request a D-User creation from the DSM.

The DSM can confirm the subscription to the UE, UE app or network entity, as appropriate. The DSM can further record the subscription in the user subscription profile in UDR.

The DSM may request D-User creation from (Hosting platform creation and configuration functions) HPCCF or HOP C/M, depending on how the HNO created the D-User functions.

Subsequently, a synch channel may be established to create a secure link between the user and the D-User.

If the initial subscription is only for a basic D-User, a user app may find the requirements of a specific UCMS service and trigger the UE. Otherwise, this could be a request to add another D-User service. Otherwise, this portion of the message flow is optional.

Specifically, a UE may trigger the new UCM service establishment request from DUCF if it is not already subscribed to. The DUCF checks the availability of the UCM service type and the other requirements such as resource availability and records the UCM service as a new subscription to UDR. The DUCF requests, from the HOP C/M or the HPCCF, as applicable, the establishment of the UCM services already subscribed to by the user, including a new UCMS service request or the original subscription from the UE with the D-User request.

HPCCF or HOP-C/M requests the D-User C/M to establish the UCMS service.

UCMS service establishment then may occur, which involves the D-User, HOP, hosting network and UE function creation and configuration.

UCMS establishment confirms to the UE and the user app, and any new software needed for the operation is sent to the UE for installation. The user can now use the UCM service.

### Establishment of a Generic UCMS Service

In the present disclosure, a UCMS service is a service given to the user to interact safely with third parties while preserving privacy. A user or a hosting network function may request the establishment of a specific UCM service. Once a D-User is created, additional UCM services may be requested by the user.

This UCM service request can be done using one or more methods described below.

In a first method, when a D-User is already available for a user, a user can make an additional subscription to the service management layer function i.e. DSM. After successful authentication of the user, the DSM may make a request to the DUCF to establish the UCM service in the existing hosting platform. DUCF may request the establishment of the UCM service from D-User manager (D-User-M) or D-User platform manager (HMF).

In this first method, a user can make a dynamic request to a control plane function (i.e. DUCF). DUCF may request the establishment of the UCM service from D-User manager (D-User-M) and the D-User-M may take an action to create the needed functions and configure them to serve the UCM service, i.e. data sharing service.

Further, in some embodiments of this first method, a user can make a request to the D-User manager. In this case, the UCM establishment can be done by the D-User agnostic to the hosting network. In this case, the D-User manager is provided with the required capabilities and also may have authority to create and configure functions inside the D-User module and request creation or configuration of functions in the hosting network, by obtaining authorization from the network. When the D-User is created, these capabilities may be provided to the D-User manager.

In a second method the D-User may not be available for a user. In this case, a user can request creation of a UCM service before the creation of a D-User and, at that time, the network may treat it as a request for a specific type of D-User together with that UCM service. The network may create the D-User as well as the UCM service.

Further, in some embodiments of this second method, the hosting network may create one or more D-Users with a D-User-M prior to assigning it to a user to reduce the delay in creation. These unassigned D-Users are assigned to the users whenever a D-User creation request is received as described above. Then, the D-User may establish a sync link with the user and synchronize user data before starting the data sharing UCM session,

### Procedure for Generic UCMS Service Establishment

In this section, a generic UCMS service establishment procedure is provided. In the current disclosure, the UCMS service is the payment method, and the functions and configuration may need to be established before using the service. This is applicable to an anonymous interaction UCMS service as well. Specifically, a user may want to obtain multiple UCM services, and the D-user may be prepared in such a way that the UCM services can be added on top of another UCM service.

A precondition for the description below is that a basic D-User is already instantiated, and a sync channel is already established.

In a first case, the D-User is created using a TEE. In this case, there are at least two options to establish a UCMS service. A first is a network aware creation and a second is a network agnostic creation.

### Network Aware Creation

In this case, the request for the additional UCM service needs to be permitted by the MNO. A network function (DUCF) may be requested to create the UCMS service (by the UE or D-User) and the DUCF interacts with the D-User-M for establishment of the UCMS service.

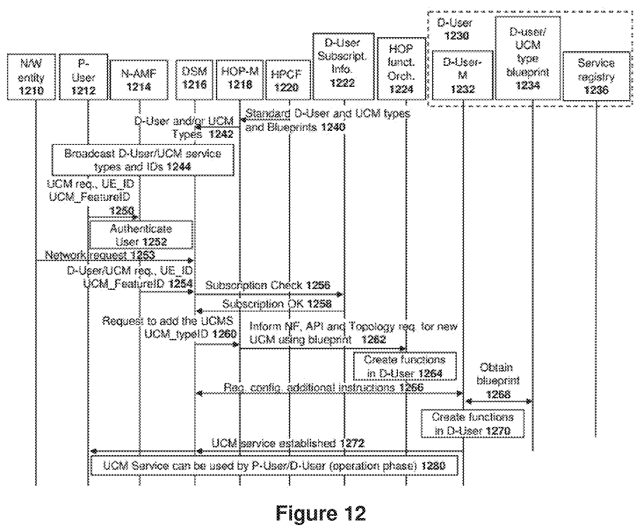

Reference is now made to FIG. 12, which provides an exemplary flow chart for network aware UCM service establishment.

The parties in FIG. 12 include a network entity 1210, A P-User 1212, an N-AMF 1214, a DSM 1216, a HOP-M 1218, an HPCF 1220, a D-User subscription information block (DSF) 1222, a HOP function orchestration 1224, and a D-User 1230. The D-User 1230 may include the D-User manager 1232, the D-User UCM type blueprint 1234 and a service registry 1236.

The HPCF 1220 may provide standard D-User and UCM types and blueprints to the HOP-M 1218 in message 1240. The HOP-M 1218 may then provide the D-User and/or UCM Types to the DSM in message 1242.

The DSM may then broadcast the D-User and/or USM service types and IDs to the P-Users 1212 and N-AMF 1214, shown with block 1244.

Collectively, messages 1240, 1242 and broadcast at block 1244 may be referred to as the network providing the UCM service types and/or D-User types.

A UCM service establishment request 1250 may then be sent from the UE (P-User 1212) to the N-AMF 1214 with UE_ID and UCM_ID and an indication that it is to be forwarded to the DSM 1216.

The Network function (N-AMF 1214) may authenticate the user request (i.e. using UE-ID) at block 1252 and forward request to DSM 1216 with message 1254.

In some cases, the network entity 1210 may also make a network request 1253 to the DSM 1216.

DSM 1216 may provide this information to DSF 1222 in message 1256, and DSF 1222 may check the subscription availability. If the subscription is not available, DSF 1222 may request DSM 1216 to follow the subscription procedure using message 1258.

Using message 1260, DSM 1216 may request HOP-M 1218 to add the UCM service to a D-User.

HOP-M 1218 may, using message 1262, check the UCM blueprint for the new UCM service and request the HOP function orchestrator 1224 to create new functions. Message 1262 may further provide information regarding the NF, API and topology.

HOP function orchestrator 1224 may then create the new internal functions in the D-User, shown at block 1264.

HOP function orchestrator 1224 may then request, using messages 1266, configuration of the new and existing functions required for the UCM service.

D-User 1230, and in particular D-User-M 1232, may use the blueprint of the UCM service to obtain the configuration details, shown with messages 1268, from D-User UCM type blueprint 1234.

Configuration of the functions may then occur at block 1270. These include D-User 1230 functions by the D-User-M 1232 and HOP functions by the HOP-M 1218 and functions outside by the MNO OAM.

The UCM service is then ready for the P-User 1212 or D-User 1230 to use, which may be signaled from D-User 1230 to P-User 1212 with message 1272.

An operations phase, shown with block 1280 can then be used.

The new functions inside D-User can also be created by the D-User function orchestrator instead of block 1264. In this case, the configuration request of message 1266 is sent by D-User-M 1232 instead of the HOP-M.

### Network Agnostic Creation

In this embodiment, when a UCMS service needs to be added, it could be done transparently to the hosting MNO if that option is allowed. This option may be an additional facility provided for the D-User. In this case, the UE may request the service from the VU-M with a message indicating the UCMS type. The UCMS may instantiate and configure the NFs required and the interfaces required.

The D-User may inform the MNO of the necessary protocols for an interaction between the MNO NFs and the D-User NFs and also traffic controlling procedures. Depending on the type of UCMS services allowed in the D-User, the network may provide sufficient instructions to the D-User when the D-User is created.

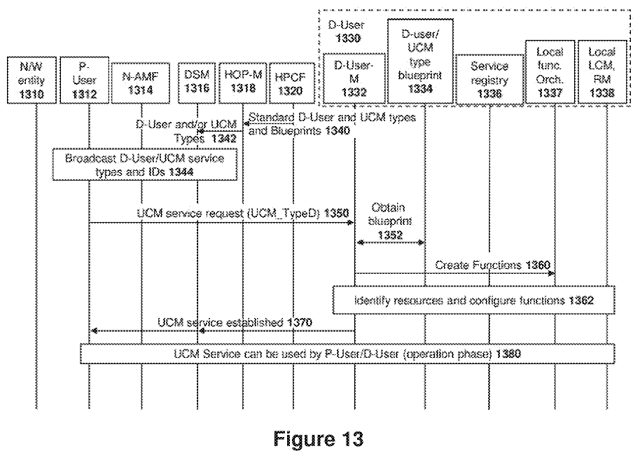

Reference is now made to FIG. 13, which provides an exemplary flow chart for the network agnostic UCM service establishment.

In this case, the difference is that the P-User can directly contact D-User and request the creation of the UCM service and D-User can create the additional functions and configure network functions. For this purpose, MNO may provide additional authority to D-User. For certain services, the MNO may carry out added actions (e.g. special exposure) which may make it aware of the establishment of a new UCM service.

The parties in FIG. 13 include a network entity 1310, A P-User 1312, an N-AMF 1314, a DSM 1316, a HOP-M 1318, an HPCF 1320, and a D-User 1330. The D-User 1330 may include the D-User manager 1332, the D-User UCM type blueprint 1334, a service registry 1336, a local function orchestrator 1337 and a local LCM, RM 1338.

The HPCF 1320 may provide standard D-User and UCM types and blueprints to the HOP-M 1318 in message 1340. The HOP-M 1318 may then provide the D-User and/or UCM Types to the DSM 1316 in message 1342.

The DSM 1316 may then broadcast the D-User and/or USM service types and IDs to the P-Users 1312 and N-AMF 1314, shown with block 1344.

Collectively, messages 1340, 1342 and broadcast at block 1344 may be referred to as the network providing the UCM service types and/or D-User types.

In the embodiment of FIG. 13, the P-User 1312 may make a UCM service request with the UCM_TypeID in message 1350 directly to the D-User-M 1332.

The D-User-M 1332 may then use the blueprint of the UCM service to obtain the configuration details, shown with messages 1352, from D-User UCM type blueprint 1334.

Creation of the functions may then occur with the local function orchestrator 1337, shown with messages 1360.

Configuration of the functions and identification of resources may then occur at block 1362.

The UCM service is then ready for the P-User 1312 or D-User 1330 to use, which may be signaled from D-User 1330 to P-User 1312 with message 1370.

An operations phase, shown with block 1380 can then be used.

In a second case, the D-User may be created by the MNO OAM. In this case, all the required NFs and interfaces can be established by the MNO, if the UCMS service creation is done with the awareness of the MNO, such as described with use case 3 above.

If the UCMS services are allowed to be performed by the D-User-M, then the D-User-M is provided with the authority to create the required functions and interfaces. For this purpose, the required Authentication, Authorization and Accounting (AAA) process may be established with the D-User prior to establishment of the UCMS service as a request for the UCMS service is directly received to D-User-M or D-User-M may decide to create the UCMS service by itself.

### Obtaining Payments for Data Sharing Anonymously

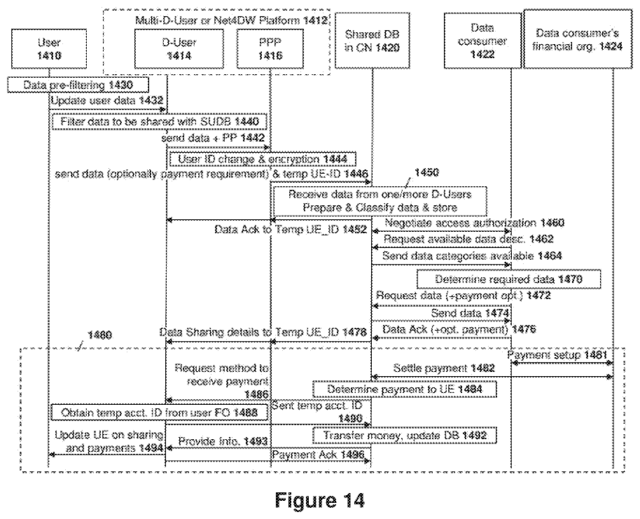

Reference is now made to FIG. 14, which illustrates an exemplary procedure to obtain a payment for the shared data from a data consumer while preserving privacy.

As described above, a data consumer may have obtained data provided by a specific user and a payment may need to be paid to the user. However, the data consumer is not aware of the user. Therefore, the data consumer would make the payment first to the SDP or the hosting network's financial organization. However, such process is not shown in detail as there is no privacy preservation requirement for that action.

The SDP/hosting network would determine how much the user would be paid according to the data sharing agreements with the user, and request a method for making the payment to the D-User through the PPP.

The request may be sent using the Temp ID used in the data sharing and the PPP could translate the address to the D-User address. The D-User would then obtain a temp account ID to deliver the payment from the user's financial organization.

Previously, this user has provided the D-user authorization to access the user's financial organization for this purpose (to obtain a temporary account ID).

This account ID is passed to the SDP through the PPP using the same previous Temp ID and the SDP/hosting network may make the payment and confirm it to D-User in a similar way using the PPP. The D-User can now check that the payment is received and send an acknowledgement to the SDP via PPP.

Thus, in the embodiment of FIG. 14, a user 1410 may use a multi-D-user or NEet4DW platform 1412 for keeping payments anonymous. Net4DW Platform 1412 may include D-User 1414 and PPP 1416.

Further, a shared DB in the CN (SUDB) 1420 may form part of the network.

A data consumer 1422 may consume data provided by user 1410 and may further have a financial organization 1424.

In the example of FIG. 14, data pre-filtering may occur at block 1430, and user data may be updated to D-User 1414 with messages 1432.

D-User 1414 may filter data to be shared with the shared user database (SUDB) at block 1440 and this data and privacy protection information may be provided to PPP 1416 in messages 1442.

PPP 1416 may perform a User ID change and encryption at block 1444, and then provide the data to the SUDB 1420 in messages 1446. In some cases, messages 1446 may optionally include a payment requirement.

At block 1450 the SUDB 1420 may receive the data from one or more D-Users, and may prepare and classify the data. The data may then be stored.

SUDB 1420 may then provide an acknowledgement of the receipt of the data back to the D-User in message 1452. This may involve sending the data to the PPP with the temporary UE ID. The PPP could then change the ID and provide it to D-User 1414.

Further, SUDB 1420 may negotiate access authorization with the data consumer 1422, as shown with messages 1460. The data consumer 1422 may then request an available data description with message 1462 and the SUDB 1420 may respond with data categories available in messages 1464.

Based on messages 1464, the data consumer 1422 may determine the data it requires at block 1470, and may make a request 1472 for the data. The request 1472 may include optional payment information.

SUDB 1420 may provide the data with message 1474, and the data consumer 1422 may provide an acknowledgement 1476. Acknowledgement 1476 may optionally include payment.

The SUDB 1420 may provide the data sharing details to the D-User 1414 in message 1478. This message 1478 may flow through PPP 1416 using the temporary user ID. PPP 1416 could then resolve this temporary user ID to the D-User and provide the data sharing details to D-User 1414.

Block 1480 shows example steps if payment is required.

Payment setup between the data consumer 1422 and the data consumer's financial organization 1424 may occur, and is shown in the example of FIG. 14 with arrow 1481.

The SUDB 1420 may contact the Data consumer's financial organization 1424 with messages 1482 to settle the payment.

The SUDB 1420 may then, at block 1484, determine the payment to the UE. In particular, the total payment received from the Data consumer's financial organization 1424 may not be paid to the UE, but rather a portion may be kept by the SUDB 1420. Thus, at block 1484, the amount to be paid to the UE is determined.

The SUDB may contact the D-User 1414 through PPP 1416 to request a method the UE wants to receive payment, shown with message 1486.

The D-User 1414 may obtain a temporary account ID from the P-User's financial organization, as shown at block 1488, and may then send this temporary account ID in message 1490 to the SUDB 1420.

SUDB may transfer the money to the account associated with the temporary account ID and perform a database update, as shown with block 1492.

The information about the payment may then be provided back to D-User 1414 in message 1493. Again, this information may be provided though PPP 1416.

The D-User 1414 may provide an update 1494 to user 1410. The D-User may further provide a payment acknowledgment 1496 to SUDB 1420.

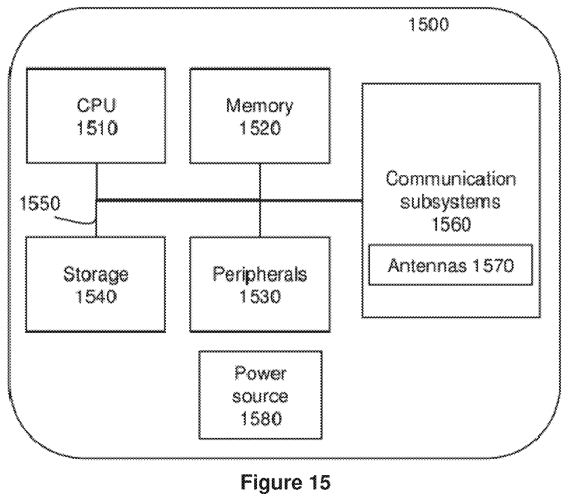

The above functionality may be implemented on any one or combination of computing devices. FIG. 15 is a block diagram of a computing device 1500 that may be used for implementing the devices and methods disclosed herein. Specific devices may utilize all of the components shown, or only a subset of the components, and levels of integration may vary from device to device. Furthermore, a device may contain multiple instances of a component, such as multiple processing units, processors, memories, transmitters, receivers, etc. The computing device 1500 may comprise a central processing unit (CPU) 1510, memory 1520, a mass storage device 1540, and peripherals 1530. Peripherals 1530 may comprise, amongst others one or more input/output devices, such as a speaker, microphone, mouse, touchscreen, keypad, keyboard, printer, display, network interfaces, and the like. Communications between CPU 1510, memory 1520, mass storage device 1540, and peripherals 1530 may occur through one or more buses 1550.

The bus 1550 may be one or more of any type of several bus architectures including a memory bus or memory controller, a peripheral bus, video bus, or the like. The CPU 1510 may comprise any type of electronic data processor. The memory 1520 may comprise any type of system memory such as static random-access memory (SRAM), dynamic random-access memory (DRAM), synchronous DRAM (SDRAM), read-only memory (ROM), a combination thereof, or the like. In an embodiment, the memory 1520 may include ROM for use at boot-up, and DRAM for program and data storage for use while executing programs.

The mass storage device 1540 may comprise any type of storage device configured to store data, programs, and other information and to make the data, programs, and other information accessible via the bus. The mass storage device 1540 may comprise, for example, one or more of a solid-state drive, hard disk drive, a magnetic disk drive, an optical disk drive, or the like.

The computing device 1500 may also include one or more network interfaces (not shown), which may comprise wired links, such as an Ethernet cable or the like, and/or wireless links to access nodes or different networks. The network interface allows the processing unit to communicate with remote units via the networks. For example, the network interface may provide wireless communication via one or more transmitters/transmit antennas and one or more receivers/receive antennas. In an embodiment, the processing unit is coupled to a local-area network or a wide-area network, for data processing and communications with remote devices, such as other processing units, the Internet, remote storage facilities, or the like.

Through the descriptions of the preceding embodiments, the teachings of the present disclosure may be implemented by using hardware only or by using a combination of software and hardware. Software or other computer executable instructions for implementing one or more embodiments, or one or more portions thereof, may be stored on any suitable computer readable storage medium. The computer readable storage medium may be a tangible or in transitory/non-transitory medium such as optical (e.g., CD, DVD, Blu-Ray, etc.), magnetic, hard disk, volatile or non-volatile, solid state, or any other type of storage medium known in the art.

Additional features and advantages of the present disclosure will be appreciated by those skilled in the art.

The structure, features, accessories, and alternatives of specific embodiments described herein and shown in the Figures are intended to apply generally to all of the teachings of the present disclosure, including to all of the embodiments described and illustrated herein, insofar as they are compatible. In other words, the structure, features, accessories, and alternatives of a specific embodiment are not intended to be limited to only that specific embodiment unless so indicated.

Moreover, the previous detailed description is provided to enable any person skilled in the art to make or use one or more embodiments according to the present disclosure. Various modifications to those embodiments will be readily apparent to those skilled in the art, and the generic principles defined herein may be applied to other embodiments without departing from the spirit or scope of the teachings provided herein. Thus, the present methods, systems, and or devices are not intended to be limited to the embodiments disclosed herein. The scope of the claims should not be limited by these embodiments, but should be given the broadest interpretation consistent with the description as a whole. Reference to an element in the singular, such as by use of the article “a” or “an” is not intended to mean “one and only one” unless specifically so stated, but rather “one or more”. All structural and functional equivalents to the elements of the various embodiments described throughout the disclosure that are known or later come to be known to those of ordinary skill in the art are intended to be encompassed by the elements of the claims.

Furthermore, nothing herein is intended as an admission of prior art or of common general knowledge. Furthermore, citation or identification of any document in this application is not an admission that such document is available as prior art, or that any reference forms a part of the common general knowledge in the art. Moreover, nothing disclosed herein is intended to be dedicated to the public regardless of whether such disclosure is explicitly recited in the claims.

In the present disclosure, “at least one” means one or more, and “a plurality of” means two or more. “and/or” describes an association relationship of associated objects, and indicates that there may be three relationships. For example, A and/or B may indicate cases includes “only A”, “both A and B”, and “only B”, where A and B may be singular or plural. The character “/” generally indicates that the associated objects are in an OR relationship. “At least one of the following items” or a similar expression thereof refers to any combination of these items, including any combination of a single item or a plurality of items. For example, “at least one of a, b, or c” may represent a, b, c, “a and b”, “a and c”, “b and c”, or “a, b and c”, where a, b, and c may be a single or multiple form.

The present disclosure encompasses various embodiments, including not only method embodiments, but also other embodiments such as apparatus embodiments and embodiments related to non-transitory computer readable storage media. Embodiments may incorporate, individually or in combinations, the features disclosed herein.

Although this disclosure refers to illustrative embodiments, this is not intended to be construed in a limiting sense. Various modifications and combinations of the illustrative embodiments, as well as other embodiments of the disclosure, will be apparent to persons skilled in the art upon reference to the description. Features disclosed herein in the context of any particular embodiments may also or instead be implemented in other embodiments. Method embodiments, for example, may also or instead be implemented in apparatus, system, and/or computer program product embodiments. In addition, although embodiments are described primarily in the context of methods and apparatus, other implementations are also contemplated, as instructions stored on one or more non-transitory computer-readable media, for example. Such media could store programming or instructions to perform any of various methods consistent with the present disclosure.

In the foregoing description, numerous details are set forth to provide an understanding of the subject disclosed herein. However, implementations may be practiced without some of these details. Other implementations may include modifications and variations from the details discussed above. It is intended that the appended claims cover such modifications and variations.

What is claimed is:

1. A method performed by a network element, the method comprising:
receiving a request from a third party to identify a process to authorize an agreement with the third party at a digital user (D-User) within the network element, the D-User representing a user and having a temporary identifier, and the request from the third party relating to a previous negotiation the D-User had with the third party using the temporary identifier while the D-User was acting on behalf of the user;
obtaining a temporary credential from a certification authority (CA) to authorize the agreement with the third party;
sending a message to the third party, the message containing the temporary credential that allows the third party to verify an authorization with the CA; and
exchanging confirmation information with the third party regarding authorization of the agreement.

2. The method of claim 1, wherein the sending the message comprises sending the message to the third party through a privacy preserving portal (PPP), and wherein the PPP changes a source identifier or source address of the message to the temporary identifier.

3. The method of claim 1, wherein the temporary credential is valid only for a single transaction or a single request.

4. The method of claim 1, wherein the obtaining the temporary credential comprises sending a message through a privacy preserving portal (PPP), wherein the PPP changes a source identifier in the message to an identifier of the PPP or an address of the PPP such that the CA is unaware of who is using services of the CA.

5. The method of claim 1, wherein, prior to obtaining the temporary credential from the CA, the method further comprising:
obtaining an authentic representation certificate from the user, wherein the authentic representation certificate is obtained by the user from the CA, and
providing the authentic representation certificate to the CA when obtaining the temporary credential.

6. The method of claim 5, wherein the authentic representation certificate transfers authority to the D-User to act on behalf of the user for a specified set of transaction types.

7. The method of claim 6, wherein the specified set of transaction types includes at least one of: making a payment to the third party; receiving a payment from the third party; negotiating with the third party on behalf of the user for transactions; agreeing to a negotiated settlement; or authorizing a transaction on behalf of the user.

8. The method of claim 1, wherein the temporary identifier is one or more of a temporary user identifier, temporary user address, temporary D-User address, or a negotiation event identifier.

9. The method of claim 1, wherein the previous negotiation was for a service obtained by the user from the third party, and wherein the process to authorize the agreement is to make payment from the user to the third party.

10. The method of claim 9, wherein the CA is a financial organization, and the temporary credential includes an identifier for the financial organization to provide a payment to the third party.

11. The method of claim 10, wherein the exchanging confirmation information includes one or more of:
receiving confirmation at the D-User that the payment was received by the third party;
sending confirmation from the D-User to the third party that the payment was received; or
receiving an acknowledgement from the third party that the third party received a signed agreement.

12. The method of claim 1, wherein the previous negotiation was for a service provided by the user to the third party, wherein the CA is a financial organization, and wherein obtaining the temporary credential comprises obtaining account details of a temporary account owned by the user.

13. The method of claim 12, wherein the third party makes a payment to the temporary account according to the previous negotiation before exchanging the confirmation information.

14. The method of claim 1, wherein the previous negotiation was for an agreement between the user and the third party for an activity.

15. A network element comprising:
at least one processor; and
at least one memory coupled to the at least one processor, wherein the at least one memory stores programming instructions that, when executed by the at least one processor, cause the network element to perform operations comprising:
receiving a request from a third party to identify a process to authorize an agreement with the third party at a digital user (D-User) within the network element, the D-User representing a user and having a temporary identifier, and the request from the third party relating to a previous negotiation the D-User had with the third party using the temporary identifier while the D-User was acting on behalf of the user;
obtaining a temporary credential from a certification authority (CA) to authorize the agreement with the third party;
sending a message to the third party, the message containing the temporary credential that allows the third party to verify an authorization with the CA; and
exchanging confirmation information with the third party regarding authorization of the agreement.

16. A method for a user to establish anonymous communication at an electronic device, the method comprising:
providing an anonymous communication identification tag (ACID) to the electronic device to identify user messages as belonging to the anonymous communication,
receiving a first message with the ACID in a service identification field and a user address in a source address field;
sending a second message to a third party after replacing the user address of the first message with a temporary identifier and changing a destination address to an address for the third party;
receiving a response from the third party at a temporary address using the temporary identifier;
generating a modified response by changing a header of the response from the temporary identifier to a user identifier; and
forwarding the modified response back to the user.

17. The method of claim 16, wherein the first message is a modified version of an original message sent by a user application, the original message comprising a third party address as the destination address in a header and an original payload encrypted with a third party public key, and
wherein the original message is modified by an Internal User Application function (IUF) by changing the header to include a network element address as the destination address and by preparing a new payload encrypted by an encryption key used for communication between the user and a digital user (D-User) in the electronic device.

18. The method of claim 17, wherein the new payload is prepared by adding the third party address and the ACID to the original payload.

19. The method of claim 17, further comprising:
receiving, by the D-User within the electronic device, the first message;
decrypting the first message using the encryption key;
removing the ACID and the third party address from the new payload;
adding the third party address as the destination address; and
forwarding the first message to a privacy preserving portal (PPP) function inside the electronic device.

20. The method of claim 19, wherein the PPP function inside the electronic device generates the second message by replacing a source address of the first message using the temporary identifier and forwards the second message to the third party.
